(19) United States
(12) Patent Application Publication
(10) Pub. No.: US 2019/0385127 A1
(43) Pub. Date: Dec. 19, 2019

(54) INFORMATION PROCESSING SYSTEM, INFORMATION PROCESSING DEVICE, AND INFORMATION PROCESSING METHOD

(71) Applicant: YUUTA HASHIMOTO, TOKYO (JP)

(72) Inventor: YUUTA HASHIMOTO, TOKYO (JP)

(73) Assignee: Ricoh Company, Ltd., Tokyo (JP)

(21) Appl. No.: 16/441,617

(22) Filed: Jun. 14, 2019

(30) Foreign Application Priority Data
Jun. 19, 2018 (JP) 2018-116523
Apr. 23, 2019 (JP) 2019-082256

(51) Int. Cl. G06Q 10/10; G06Q 10/02; G06F 9/54; G06F 16/176

(52) U.S. Cl. CPC G06Q 10/1095; G06F 16/176; G06F 9/542; G06Q 10/02

(57) ABSTRACT

An information processing system includes circuitry to: acquire information on reservation of a meeting; in response to the acquisition of the information on the reservation of the meeting, generate personal content to be used by each of attendees of the reserved meeting; and based on the information on the reservation, send a notification indicating connection information for accessing the personal content and shared content to be shared and used by the attendees of the reserved meeting.

### CROSS-REFERENCE TO RELATED APPLICATIONS

This patent application is based on and claims priority pursuant to 35 U.S.C. § 119(a) to Japanese Patent Application Nos. 2018-116523, filed on Jun. 19, 2018, and 2019-082256, filed on Apr. 23, 2019, in the Japan Patent Office, the entire disclosure of which is hereby incorporated by reference herein.

### BACKGROUND

### Technical Field

The present invention relates to an information processing system, an information processing device, and an information processing method.

### Description of the Related Art

Electronic meeting systems that enable electronic meetings to be held among a plurality of terminal devices via communication networks have been known. In some of these electronic meeting systems, content shared and used by attendees and content personally used by the attendees can be stored in a server. A technology to share a whiteboard online has also been known.

Examples of the content personally used by the attendees (hereinafter, also referred to as “personal content”) may include a virtual whiteboard (hereinafter, also referred to as a “personal board”) that is used for taking notes or the like of the contents related to the electronic meeting. However, in the related art, content shared and used by attendees of an electronic meeting (hereinafter also referred to as “shared content”) and a personal board are not associated with each other. Therefore, users need to record, in their personal boards, when the meetings are held, which meeting their notes relate to, and which shared content their notes are associated with. That is, the users need to manage association between shared content and the personal boards by themselves.

### SUMMARY

Example embodiments of the present invention include an information processing system including circuitry to: acquire information on reservation of a meeting; in response to the acquisition of the information on the reservation of the meeting, generate personal content to be used by each of attendees of the reserved meeting; and based on the information on the reservation, send a notification indicating connection information for accessing the personal content and shared content to be shared and used by the attendees of the reserved meeting.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 illustrates an example of an overall configuration of a meeting service system according to a first embodiment;

FIG. 2 illustrates an example of an outline of generation of a shared board and a personal board;

FIG. 3 illustrates an example of a hardware configuration of a computer;

FIG. 4 illustrates an example of a functional configuration of the meeting service system according to the first embodiment;

FIG. 5 is a sequence diagram illustrating an example of a meeting reservation process according to the first embodiment;

FIG. 6 illustrates an example of a meeting reservation screen;

FIG. 7 illustrates an example of meeting information;

FIG. 8 illustrates an example of board management information;

FIG. 9 illustrates an example of check-in information;

FIG. 10 illustrates an example of schedule information;

FIG. 11 is a sequence diagram illustrating an example of a meeting start process according to the first embodiment;

FIG. 12 illustrates an example of a schedule confirmation screen;

FIG. 13 is a sequence diagram illustrating an example of a meeting attendance process according to the first embodiment;

FIG. 14 illustrates an example of a personal board screen;

FIG. 15 is a sequence diagram illustrating an example of a meeting end process according to the first embodiment;

FIG. 16 illustrates an example of a functional configuration of a meeting service system according to a second embodiment;

FIG. 17 is a sequence diagram illustrating an example of a meeting reservation process according to the second embodiment;

FIG. 18 illustrates an example of board management information;

FIG. 19 is a sequence diagram illustrating an example of a meeting attendance process according to the second embodiment;

FIG. 20 is a sequence diagram illustrating an example of a meeting end process according to the second embodiment;

FIG. 21 illustrates an example of a functional configuration of a meeting service system according to a third embodiment;

FIG. 22 is a sequence diagram illustrating an example of a meeting reservation process according to the third embodiment;

FIG. 23 illustrates an example of board management information;

FIG. 24 is a sequence diagram illustrating an example of a meeting attendance process according to a third embodiment;

FIG. 25 illustrates an example of a redirect screen;

FIG. 26 illustrates an example of an e-mail address input screen;

FIG. 27 is a sequence diagram illustrating an example of a meeting start process according to a fourth embodiment;

FIG. 28 illustrates an example of an overall configuration of a meeting service system according to a fifth embodiment;

FIG. 29 illustrates an example of an outline of generation of a shared screen and a personal board;

FIG. 30 illustrates an example of a functional configuration of a meeting service system according to a sixth embodiment;

FIG. 31 is a sequence diagram illustrating an example of a meeting reservation process according to the sixth embodiment;

FIG. 32 illustrates an example of board management information;

FIG. 33 illustrates an example of check-in information;

FIG. 34 is a sequence diagram illustrating an example of a meeting attendance process according to the sixth embodiment;

FIG. 35 illustrates an example of a reminder notification e-mail screen; and

FIG. 36 illustrates an example of a personal board screen.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, embodiments of the present disclosure are described with reference to the drawings. In each of the following embodiments, a meeting service system 1 implementing an electronic meeting service in which shared content and personal content in an electronic meeting are managed in association with each other is described. The personal content is, for example, a personal board. The shared content is, for example, a virtual whiteboard (hereinafter, also referred to as a “shared board”) for sharing, by attendees of a meeting, materials and the like related to an electronic meeting.

The personal content and the shared content are not limited to the personal board and the shared board, respectively. The personal content may be any content used personally by attendees of an electronic meeting. Similarly, the shared content may be any content shared and used by attendees of an electronic meeting. Examples of the content may include any data, such as audio data, image data, and document data.

### First Embodiment

### Overall Configuration

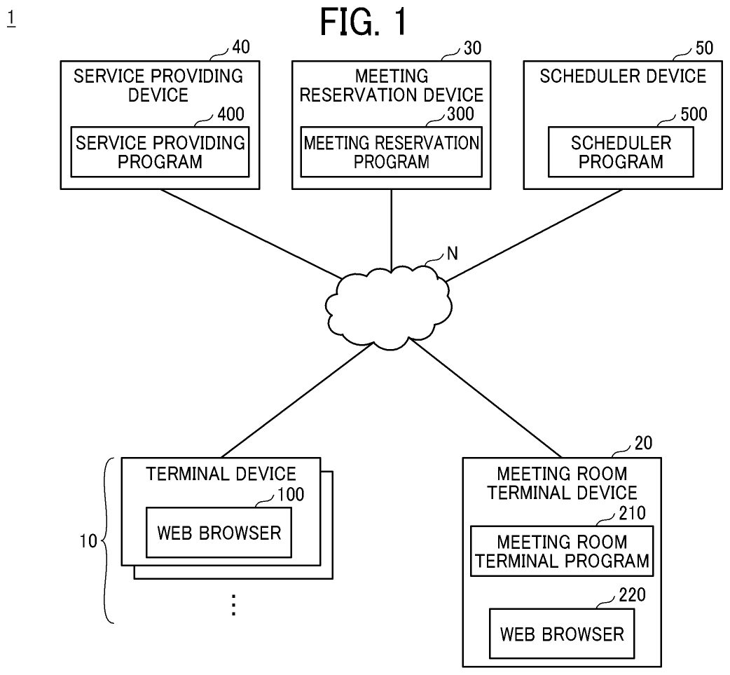

First, an overall configuration of a meeting service system 1 according to a first embodiment is described with reference to FIG. 1. FIG. 1 illustrates an example of a configuration of the meeting service system 1 according to the present embodiment.

As illustrated in FIG. 1, the meeting service system 1 according to the present embodiment includes: a plurality of terminal devices 10; one or more meeting room terminal devices 20; a meeting reservation device 30; a service providing device 40; and a scheduler device 50. The terminal devices 10, the meeting room terminal device(s) 20, the meeting reservation device 30, the service providing device 40, and the scheduler device 50 are communicably connected via a communication network N, such as the Internet. The communication network N may be, for example, a local communication network, such as an internal network.

The terminal devices 10 are, for example, personal computers (PCs) used by attendees (including an organizer) of the electronic meeting. A web browser 100 is installed in each of the terminal devices 10. A user of the terminal device 10 can use the web browser 100 to use an electronic meeting service (hereinafter, also simply referred to as “meeting service”) provided by the service providing device 40.

At this time, the user can use, on the web browser 100, a shared board and a personal board generated by the service providing device 40. By using the shared board, the users of the terminal devices 10 can share materials, notes, and the like related to an electronic meeting with other users (that is, other attendees of the electronic meeting). By using the personal board, on the other hand, the users of the terminal devices 10 can take notes or the like related to the electronic meeting on the personal board. Hereinafter, the electronic meeting is also simply referred to as a “meeting.”

The user can use the web browser 100 to use the scheduling service provided by the scheduler device 50. At this time, the user can use the scheduling service on the web browser 100 to make a reservation for a meeting. By using the scheduling service, confirmation, and the like of the user's schedule can be performed on the web browser 100.

Other than PCs, the terminal devices 10 may be any devices provided with the web browser 100 (for example, a smartphone, a tablet terminal, an electronic blackboard device, and a game device). Hereinafter, each of the plurality of terminal devices 10 is referred to as a “terminal device 10A,” a “terminal device 10B” and so forth when they are distinguished from one another. A web browser 100 provided in the terminal device 10A is also referred to as a “web browser 100A,” a web browser 100 provided in the terminal device 10B is also referred to as a “web browser 100B,” and so forth.

The meeting room terminal device 20 is a computer or a computer system used for starting or ending the use of the meeting service. The meeting room terminal device 20 is installed in any room or space, such as an actual meeting room. Starting the use of the meeting service by using the meeting room terminal device 20 is also referred to as “check in,” and ending the use of the meeting service is also referred to as “check out.”

A meeting room terminal program 210 and a web browser 220 are installed in the meeting room terminal device 20.

When the meeting service is to be started by using the meeting room terminal device 20, the meeting room terminal program 210 receives input of a meeting reservation number from a user. The meeting reservation number is information for starting the use of the reserved meeting. Then, when the use of the meeting service is started, the meeting room terminal device 20 displays a shared board on the web browser 220.

Examples of the meeting room terminal device 20 may include any device in which the meeting room terminal program 210 and the web browser 220 are installed (for example, a PC, an electronic blackboard device, a monitor device (display device), a digital signage device, and a projector device).

The meeting reservation device 30 is a computer or a computer system for linking the meeting service and a scheduler service. A meeting reservation program 300 is installed in the meeting reservation device 30.

When a meeting is reserved in the scheduling service, the meeting reservation device 30 requests the service providing device 40 to generate a shared board and a personal board according to the contents of the reservation by the meeting reservation program 300. In addition, when a shared board and a personal board are generated by the service providing device 40, the meeting reservation device 30 registers a uniform resource locator (URL) for accessing the shared board and personal board in the schedule of the attendees of the reserved meeting.

The service providing device 40 is a computer or a computer system that provides a meeting service in the form of, for example, a cloud service. A service providing program 400 is installed in the service providing device 40. In response to a request from the meeting reservation device 30, the service providing device 40 generates a shared board or a personal board by using the service providing program 400.

Further, the service providing device 40 performs various processes (for example, synchronization among the terminal devices 10 of the attendees attending the meeting) by the service providing program 400 to implement the meeting service.

The scheduler device 50 is a computer or a computer system that provides a scheduling service in the form of, for example, a cloud service. A scheduler program 500 is installed in the scheduler device 50. In response to a request from the terminal device 10, the scheduler device 50 uses the scheduler program 500 to make a reservation for a meeting or the like.

An example of the configuration of the meeting service system 1 is illustrated in FIG. 1 but other configurations may be employed. For example, the meeting reservation device 30 and the scheduler device 50 may be integrated with each other. Also, for example, the meeting reservation device 30 and the service providing device 40 may be integrated with each other. Also, for example, the meeting service system 1 may include a plurality of service providing devices 40.

### Outline of Generation of Shared Board and Personal Board

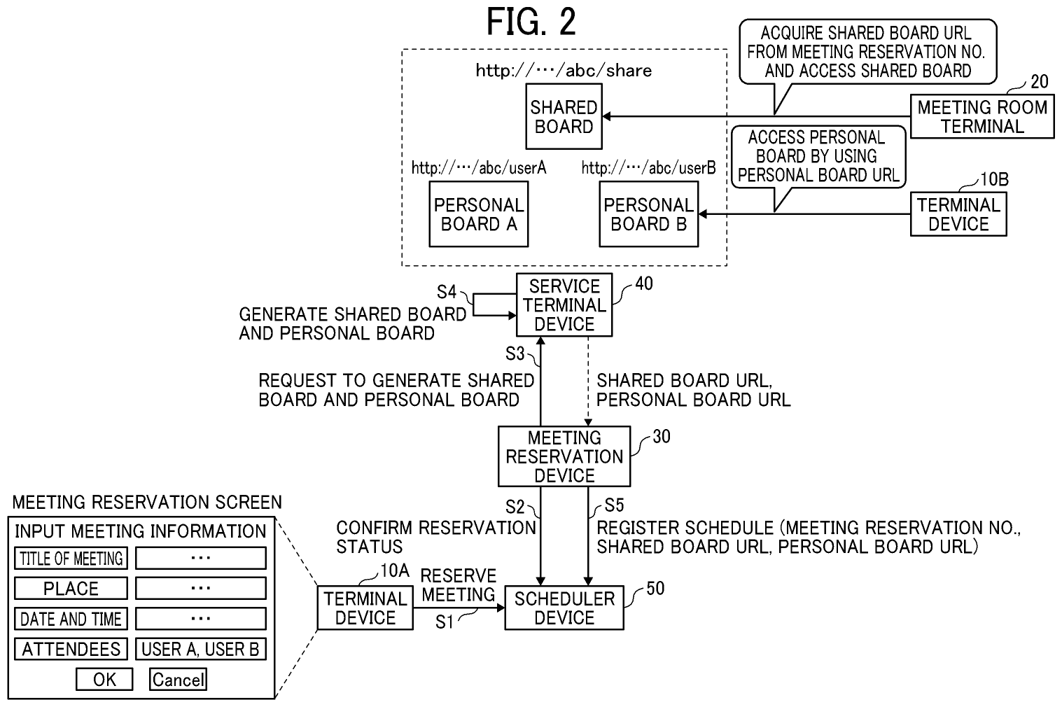

Here, as an example, an outline of a case in which a user A of the terminal device 10A reserves a meeting by using the scheduling service, and a shared board and a personal board of this meeting are generated is described with reference to FIG. 2. FIG. 2 illustrates an example of an outline of generation of the shared board and the personal board.

S1) The user A of the terminal device 10A reserves a meeting on a meeting reservation screen displayed on the web browser 100A. On the meeting reservation screen, for example, a title of meeting and place (a place of the meeting room in which the meeting room terminal device 20 is installed, for example), the date and time, attendees and the like are input. In this manner, the meeting is reserved on the scheduling service provided by the scheduler device 50.

S2) The meeting reservation program 300 of the meeting reservation device 30 confirms the meeting reservation status in the scheduling service. The confirmation of the meeting reservation status is repeatedly performed, for example, at predetermined time intervals.

S3) When it is confirmed that a new meeting reservation has been made, the meeting reservation program 300 of the meeting reservation device 30 requests the service providing device 40 to generate a shared board and a personal board. At this time, the meeting reservation program 300 requests to generate a personal board for each attendee of the reserved meeting (in the example illustrated in FIG. 2, the number of attendees is two: “user A” and “user B”).

S4) In response to the request from the meeting reservation device 30, the service providing program 400 of the service providing device 40 generates a shared board and a personal board. In this manner, a shared board, and a personal board for each attendee of the reserved meeting (in the example illustrated in FIG. 2, “personal board A” for the user A and “personal board B” for the user B) are generated.

Then, the service providing program 400 of the service providing device 40 sends back a URL for accessing the shared board and a URL for accessing the personal board to the meeting reservation device 30. Hereinafter, the URL for accessing the shared board is also referred to as “shared board URL,” and the URL for accessing the personal board is also referred to as “personal board URL.”

S5) Regarding the schedule of an attendee of the reserved meeting, the meeting reservation program 300 of the meeting reservation device 30 registers the “meeting reservation number,” the “shared board URL,” and the “personal board URL” for accessing the personal board of the attendee. The meeting reservation number is generated by the meeting reservation program 300 after the shared board is generated, for example.

In this manner, when a meeting is reserved, a meeting reservation number, a shared board URL, and a personal board URL of a personal board of each attendee of the meeting are registered in the schedule of the attendee. In this manner, for example, when starting the reserved meeting, the user A can acquire the shared board URL by inputting the meeting reservation number to the meeting room terminal device 20, and cause the shared board to be displayed on the web browser 220 of the meeting room terminal device 20.

Further, the user A can access own personal board A by inputting the personal board URL of the personal board A on the web browser 100A of the terminal device 10A. Similarly, the user B can access own personal board B by inputting the personal board URL of the personal board B on the web browser 100B of the terminal device 10B.

Furthermore, at this time, the user A and the user B can also access the shared board by inputting the shared board URL on the web browser 100 of their own terminal devices 10.

As described above, by registering the meeting reservation number, the shared board URL, and the personal board URL in the schedule of each attendee of the meeting, each attendee can manage the shared board and the personal board in association with each other. In addition, since the meeting reservation number, the shared board URL, and the personal board URL are registered in the schedule, each attendee can easily find out, for each URL of the personal board in which recording notes or the like are recorded for a meeting, when the meeting is held or what it is discussed in the meeting.

### Hardware Configuration

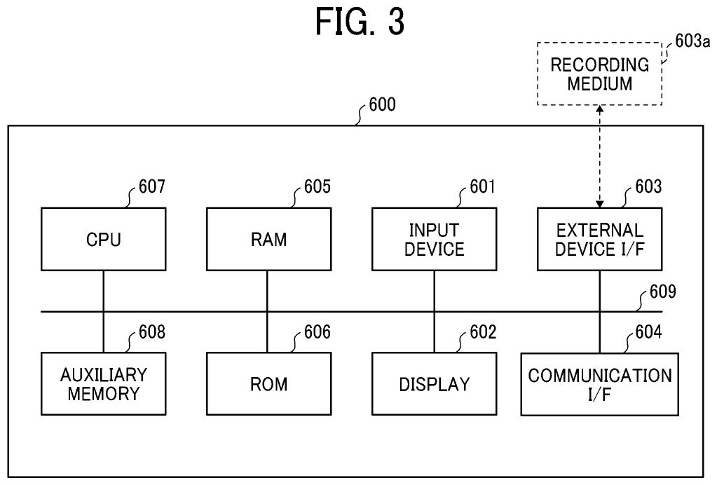

Next, hardware configurations of the terminal device 10, the meeting room terminal device 20, the meeting reservation device 30, the service providing device 40, and the scheduler device 50 according to the present embodiment are described. The terminal device 10, the meeting room terminal device 20, the meeting reservation device 30, the service providing device 40, and the scheduler device 50 according to the present embodiment can be implemented, for example, by the hardware configuration of the computer 600 illustrated in FIG. 3. FIG. 3 illustrates an example of a hardware configuration of the computer 600.

The computer 600 illustrated in FIG. 3 includes: an input device 601; a display 602; an external device I/F 603; a communication I/F 604; a random access memory (RAM) 605; a read only memory (ROM) 606; a central processing unit (CPU) 607; and an auxiliary memory 608. These pieces of hardware are connected via a bus 609 to communicate with one another.

The input device 601 includes, for example, a keyboard, a mouse, and a touch panel, and is used by a user to perform various operations. The display 602 is, for example, a liquid crystal display (LCD), and displays a process result of the computer 600. Note that the meeting reservation device 30, the service providing device 40, and the scheduler device 50 do not necessarily have to include at least one of the input device 601 and the display 602.

The external device I/F 603 is an interface with an external device. The external device is, for example, a recording medium 603a. The computer 600 can read data from and write data to the recording medium 603a via the external device I/F 603. Examples of the recording medium 603a may include a secure digital (SD) memory card, a universal serial bus (USB) flash drive, a compact disk (CD), and a digital versatile disk (DVD).

The communication I/F 604 is an interface for connecting the computer 600 to a communication network N. The RAM 605 is a volatile semiconductor memory that temporarily stores programs and data. The ROM 606 is a non-volatile semiconductor memory that holds data even after the device is turned off.

The CPU 607 reads programs or data from a memory, such as the ROM 606 and the auxiliary memory 608, onto the RAM 605, and executes processes based on the programs and the data to implement control and functions of the entire computer 600.

The auxiliary memory 608 is, for example, a hard disk drive (HDD) or a solid state drive (SSD), and is a non-volatile memory storing programs and data. The auxiliary memory 608 may include, for example, an operating system (OS), which is basic software for controlling the entire computer 600, and application software for providing various functions on the OS. Further, the web browser 100 is stored in the auxiliary memory 608 of the terminal device 10. Similarly, the meeting room terminal program 210 and the web browser 220 are stored in the auxiliary memory 608 of the meeting room terminal device 20. Similarly, the meeting reservation program 300 is stored in the auxiliary memory 608 of the meeting reservation device 30. Similarly, the service providing program 400 is stored in the auxiliary memory 608 of the service providing device 40. Similarly, the scheduler program 500 is stored in the auxiliary memory 608 of the scheduler device 50.

The terminal device 10, the meeting room terminal device 20, the meeting reservation device 30, the service providing device 40, and the scheduler device 50 according to the present embodiment can implement various processes according to the present embodiment by the hardware configuration of the computer 600 illustrated in FIG. 3. The terminal device 10, the meeting room terminal device 20, the meeting reservation device 30, the service providing device 40, and the scheduler device 50 according to the present embodiment may be implemented by hardware configurations of a plurality of computers 600.

### Functional Configuration

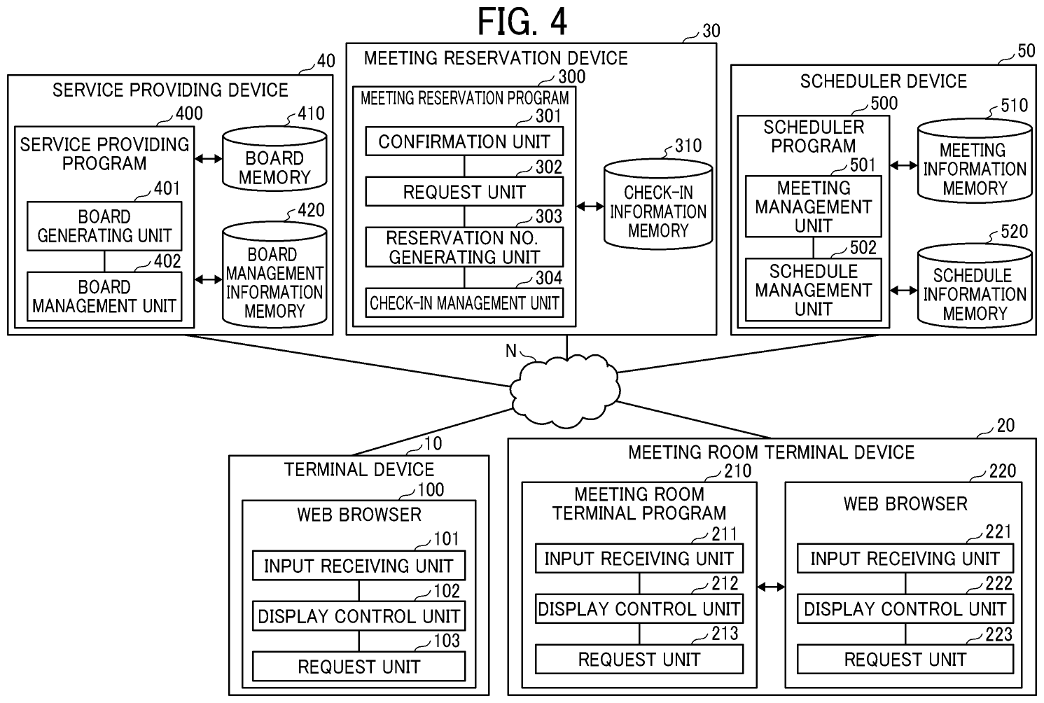

Next, a functional configuration of the meeting service system 1 according to the present embodiment is described with reference to FIG. 4. FIG. 4 illustrates an example of a functional configuration of the meeting service system 1 according to the first embodiment.

### Terminal Device

As illustrated in FIG. 4, the terminal device 10 according to the present embodiment includes an input receiving unit 101, a display control unit 102, and a request unit 103. These units are implemented by processes that the web browser 100 causes the CPU (such as the CPU 607) to execute. In particular, when the web browser 100 causes the CPU to execute processes related to web content, all or a part of the processes performed by each of the units is implemented. The web content refers to various types of data acquired from a web server (or a program functioning as a web server) and may be the hyper text markup language (HTML), cascading style sheets (CSS), and JavaScript (registered trademark).

The input receiving unit 101 receives various types of input (for example, input of a personal board URL and a shared board URL) from the user. The display control unit 102 displays various screens (for example, screens including a personal board (hereinafter, also referred to as “personal board screen”)). The request unit 103 sends various requests (for example, a meeting reservation request).

### Meeting Room Terminal Device

As illustrated in FIG. 4, the meeting room terminal device 20 according to the present embodiment includes an input receiving unit 211, a display control unit 212, and a request unit 213. These units are implemented by processes that the meeting room terminal program 210 causes the CPU to execute.

The meeting room terminal device 20 according to the present embodiment includes an input receiving unit 221, a display control unit 222, and a request unit 223. These units are implemented by processes that the web browser 220 causes the CPU to execute. In particular, when the web browser 220 causes the CPU to execute processes related to web content, all or a part of the processes performed by each of the units is implemented.

The input receiving unit 211 receives various types of input (for example, input of a meeting reservation number) from the user. The display control unit 212 displays various screens (for example, a screen for inputting a meeting reservation number). The request unit 213 sends various requests (for example, a request for checking in).

The input receiving unit 221 receives various types of input (for example, input of a shared board URL) from the user. The display control unit 222 displays various screens (for example, screens including a shared board (hereinafter, also referred to as “shared board screen”)). The request unit 223 sends various requests (for example, a shared board display request).

### Meeting Reservation Device

As illustrated in FIG. 4, the meeting reservation device 30 according to the present embodiment includes a confirmation unit 301, a request unit 302, a reservation number generating unit 303, and a check-in management unit 304. These units are implemented by processes that the meeting reservation program 300 causes the CPU to execute.

The meeting reservation device 30 according to the present embodiment includes a check-in information memory 310. The check-in information memory 310 may be implemented by using, for example, an auxiliary memory. The check-in information memory 310 may be implemented by using, for example, a memory connected to the meeting reservation device 30 via the communication network N.

The confirmation unit 301 confirms a meeting reservation status in the scheduling service every predetermined time. The request unit 302 sends various requests (for example, a shared board generation request, a personal board generation request, and a schedule request). The reservation number generating unit 303 generates a meeting reservation number when the service providing device 40 generates a shared board.

When a meeting reservation number is generated, the check-in management unit 304 generates check-in information and stores the generated check-in information in the check-in information memory 310. The check-in information refers to information in which a meeting reservation number and a shared board URL are associated with each other. Details of the check-in information are described later.

Further, in response to a request from the meeting room terminal device 20, the check-in management unit 304 refers to the check-in information memory 310 and determines whether check-in is possible. Then, when it is determined that the check-in is possible, the check-in management unit 304 sends back information indicating that check-in is made successfully to the meeting room terminal device 20. The check-in management unit 304 also sends the shared board URL back to the meeting room terminal device 20.

### Service Providing Device

As illustrated in FIG. 4, the service providing device 40 according to the present embodiment includes a board generating unit 401 and a board management unit 402. These units are implemented by processes that the service providing program 400 causes the CPU to execute.

Further, the service providing device 40 according to the present embodiment includes a board memory 410 and a board management information memory 420. Each memory can be implemented by using, for example, an auxiliary memory. At least one of the memories may be implemented by using, for example, a memory connected to the service providing device 40 via the communication network N.

The board generating unit 401 generates a shared board or a personal board in response to a request from the meeting reservation device 30. The board generating unit 401 stores the generated shared board and personal board in the board memory 410.

When the shared board and the personal board are generated, the board management unit 402 generates board management information, and stores the generated board management information in the board management information memory 420. The board management information refers to information in which the shared board URL and the personal board URL are associated with each other. Details of the board management information are described later.

### Scheduler Device

As illustrated in FIG. 4, the scheduler device 50 according to the present embodiment includes a meeting management unit 501 and a schedule management unit 502. These units are implemented by processes that the scheduler program 500 causes the CPU to execute.

The scheduler device 50 according to the present embodiment includes a meeting information memory 510 and a schedule information memory 520. Each memory can be implemented by using, for example, an auxiliary memory. At least one of the memories may be implemented by using, for example, a memory connected to the scheduler device 50 via the communication network N.

The meeting management unit 501 generates meeting information in response to a request from the terminal device 10, and stores the generated meeting information in the meeting information memory 510. The meeting information refers to information on a reserved meeting, and includes, for example, title of meeting, place, date and time, and attendees. Details of the meeting information are described later.

The schedule management unit 502 updates the schedule information stored in the schedule information memory 520 in response to a request from the meeting reservation device 30. In particular, the schedule management unit 502 registers the meeting reservation number, the shared board URL, the personal board URL of the personal board of the attendee, and the like with respect to the schedule information of the meeting attendee. The schedule information refers to information related to a schedule of a user, and includes, for example, user identification information for identifying the user, a date, time, and registered contents. Details of the schedule information are described later.

### Details of Process

Next, details of the process of the meeting service system 1 according to the present embodiment are described.

### Meeting Reservation Process

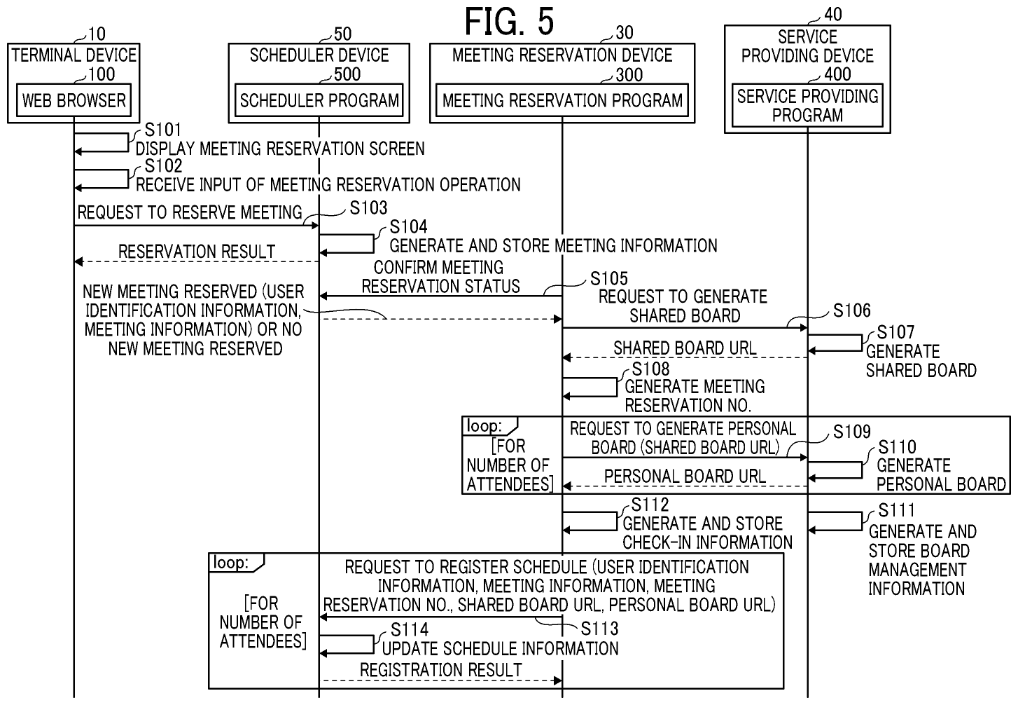

Hereinafter, a process for reserving an electronic meeting by using the meeting service system 1 according to the present embodiment is described with reference to FIG. 5. FIG. 5 is a sequence diagram illustrating an example of a meeting reservation process according to the first embodiment.

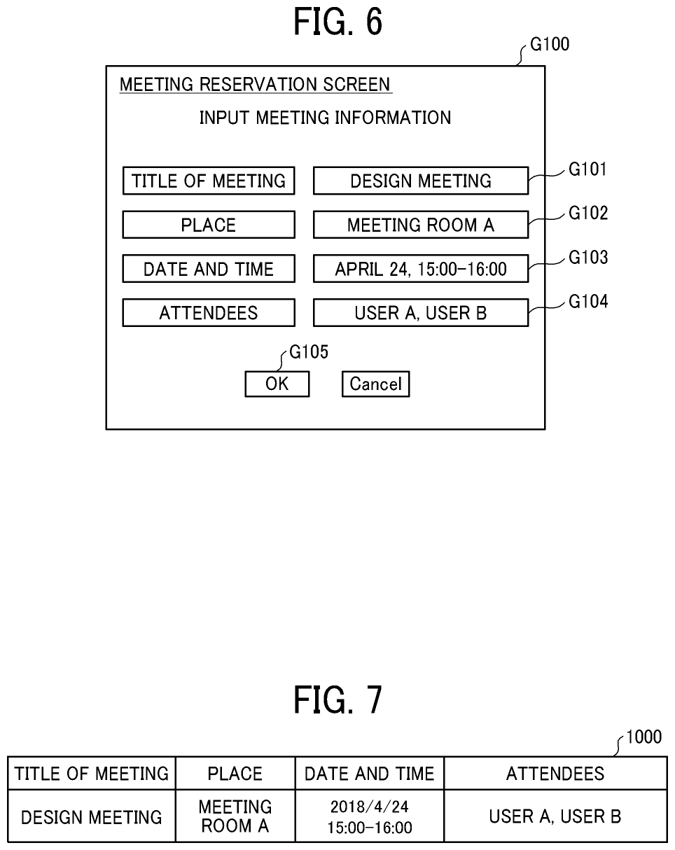

First, the display control unit 102 of the web browser 100 displays, for example, a meeting reservation screen G100 illustrated in FIG. 6 (step S101). The meeting reservation screen G100 illustrated in FIG. 6 is a screen for making a reservation of a meeting. The meeting reservation screen G100 illustrated in FIG. 6 is displayed, for example, when the user presses a predetermined link on the screen of the scheduling service displayed on the web browser 100.

The meeting reservation screen G100 illustrated in FIG. 6 includes, for example, a title of meeting input field G101, a place input field G102, a date and time input field G103, an attendee input field G104, and an OK button G105. The place, the date, the attendee, and so forth may be selected from, for example, a list of input candidates (for example, a list of place candidates, a list of date candidates, and a list of attendee candidates).

In the title of meeting input field G101, the name of the meeting to be reserved is input. In the place input field G102, the place of the meeting room (that is, the place in which the meeting room terminal device 20 is installed or the place in which the meeting room terminal device 20 is used) is input. In the date and time input field G103, the date and time the meeting is to be held are input. In the attendee input field G104, attendees in the meeting are input.

The user inputs the title of meeting, the place, the date and time, and the attendees in the title of meeting input field G101, the place input field G102, the date and time input field G103 and the attendee input field G104, respectively, and then presses the OK button G105. In this manner, a meeting reservation operation can be performed. Hereinafter, description is continued on the assumption that the meeting reservation operation has been performed by the user on the meeting reservation screen G100 illustrated in FIG. 6.

The input receiving unit 101 of the web browser 100 receives input of a meeting reservation operation (step S102). Next, the request unit 103 of the web browser 100 sends a meeting reservation request to the scheduler device 50 (step S103). The meeting reservation request includes, for example, various types of information (for example, title of meeting, place, date and time, attendees) input on the meeting reservation screen G100 illustrated in FIG. 6.

Upon receiving the meeting reservation request, the meeting management unit 501 of the scheduler program 500 generates meeting information from various types of information included in the meeting reservation request. Then, the meeting management unit 501 stores the generated meeting information in the meeting information memory 510 (step S104). In this manner, the meeting is reserved.

Then, for example, the meeting management unit 501 sends a reservation result indicating that the reservation of the meeting is successfully done back to the terminal device 10. When, for example, another meeting has already been reserved at that place and date, the meeting management unit 501 sends a reservation result indicating that the reservation of the meeting is not successfully done back to the terminal device 10.

An example of the meeting information generated in step S104 above is illustrated in FIG. 7. FIG. 7 illustrates an example of meeting information 1000. The meeting information 1000 illustrated in FIG. 7 includes, as data items, the title of meeting, the place, the date and time, and the attendees.

In the data item “title of meeting,” the name of the meeting included in the meeting reservation request is set. In the data item “place,” the place included in the meeting reservation request is set. In the data item “date and time,” the date and time included in the meeting reservation request is set. In the data item “attendee,” the attendee included in the meeting reservation request is set.

In the meeting information 1000 illustrated in FIG. 7, “design meeting” as the title of meeting, “meeting room A” as the place, “2018/4/24 15:00-16:00” as the date and time, “user A, user B” are set as the attendees, respectively.

In this manner, the meeting information refers to information in which the title of meeting, the place, the date and time, and the attendees of the reserved meeting are associated with each other. The meeting information may include various types of information (for example, information on the user who has reserved the meeting) in addition to the information described above.

Referring back to FIG. 5, the confirmation unit 301 of the meeting reservation program 300 confirms the meeting reservation status in the scheduling service every predetermined time (step S105). That is, the confirmation unit 301 confirms whether new meeting information is stored in the meeting information memory 510 of the scheduler device 50 every predetermined time.

When new meeting information is stored in the meeting information memory 510, the scheduler device 50 sends back information indicating that a new reservation has been made. At this time, together with the information indicating that a new reservation has been made, meeting information and user identification information of attendees included in the meeting information are sent back. Here, the user identification information refers to information for identifying each user on the scheduling service, such as an e-mail address.

On the other hand, when no new meeting information is not stored in the meeting information memory 510, the scheduler device 50 sends back information indicating that no new reservation has been made. Hereinafter, description is continued on the assumption that information indicating that a new reservation has been made is sent from the scheduler device 50.

As a time interval which the confirmation unit 301 confirms a meeting reservation condition, arbitrary time can be set. Further, instead of the confirmation unit 301 confirming the meeting reservation status, for example, when the meeting information is stored in the meeting information memory 510, the scheduler program 500 may notify the meeting reservation device 30 that a new reservation has been made.

The request unit 302 of the meeting reservation program 300 sends, to the service providing device 40, a request to generate a shared board (shared board generation request) to be shared and used by the attendees of the newly reserved meeting (step S106). The shared board generation request includes, for example, the meeting information or the date and time set in the meeting information.

Upon receiving the request to generate a shared board, the board generating unit 401 of the service providing program 400 generates a shared board (step S107). Then, the board generating unit 401 sends the shared board URL back to the meeting reservation device 30. The shared board is stored in the board memory 410.

When the shared board URL is sent back, the reservation number generating unit 303 of the meeting reservation program 300 generates a meeting reservation number (step S108). The meeting reservation number may be generated before step S106 described above, or may be generated before step S112 described later.

Next, the request unit 302 of the meeting reservation program 300 sends, to the service providing device 40, a request to generate a personal board (a personal board generation request) used individually for each attendee of the newly reserved meeting (step S109). At this time, the request unit 302 sends a personal board generation request to the service providing device 40 for each attendee (that is, user identification information) included in the meeting information sent back from the scheduler device 50. The personal board generation request includes information for identifying a shared board corresponding to the personal board generated in step S110 described later. Example of such information may include a shared board URL, and a process ID when generating the shared board. In this manner, the shared board associated with the personal board generated in step S110 described later can be identified.

The shared board generation request in step S106 described above and the personal board generation request in step S109 may be performed in one generation request. For example, when N attendees are included in the meeting information, the request unit 302 may send, to the service providing device 40, one board generation request for generating one shared board and N personal boards.

Upon receiving the personal board generation request, the board generating unit 401 of the service providing program 400 generates a personal board (step S110). At this time, the board generating unit 401 generates a personal board including a link to the URL of the shared board generated in step S107 described above.

Then, the board generating unit 401 sends the personal board URL back to the meeting reservation device 30. The personal board is stored in the board memory 410. In this manner, personal boards corresponding to the number of attendees of the reserved meeting are generated.

After generating the board management information, the board management unit 402 of the service providing program 400 stores the generated board management information in the board management information memory 420 (step S111). The board management unit 402 associates the shared board URL of the shared board generated in step S107, the personal board URL of the personal board generated in step S110, and the date and time of the reserved meeting, so as to generate board management information.

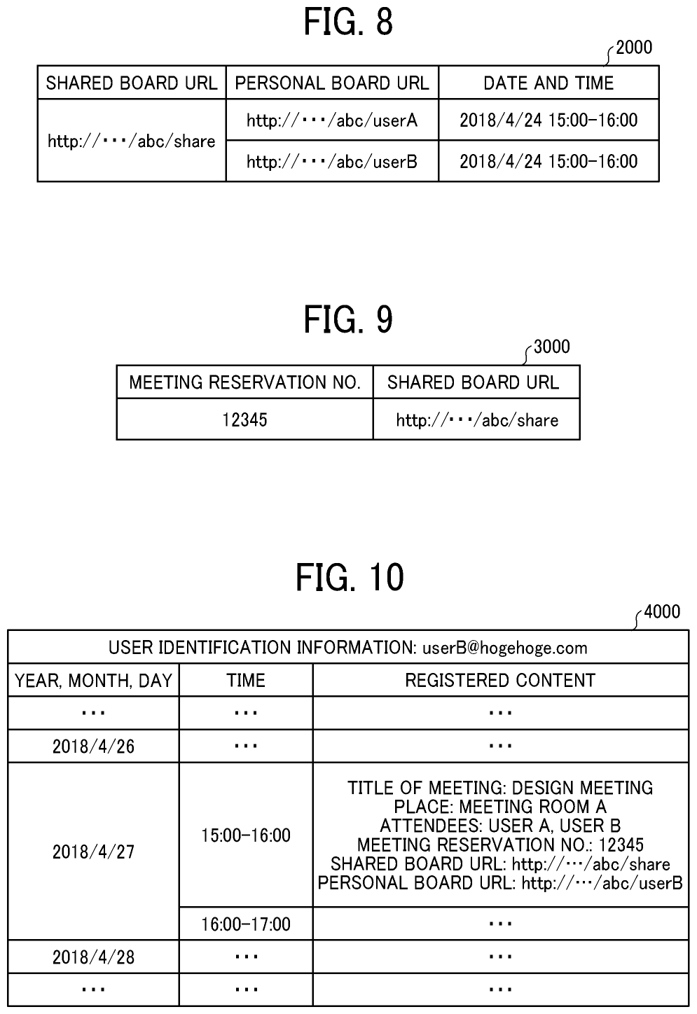

An example of the board management information generated in step S111 described above is illustrated in FIG. 8. FIG. 8 illustrates an example of board management information 2000. The board management information 2000 illustrated in FIG. 8 includes, as data items, the shared board URL, the personal board URL, and the date and time.

In the data item “shared board URL,” the URL of the shared board generated in step S107 described above is set. In the data item “personal board URL,” the URL of each personal board generated in step S110 described above is set. In the data item “date and time,” the date and time of the reserved meeting is set.

In the board management information 2000 illustrated in FIG. 8, “http://.../abc/share” is set as the shared board URL. Also, “http://.../abc/userA” and “http://.../abc/userB” are set as the personal board URL. Furthermore, “2018/4/24 15:00-16:00” is set as the date and time for each of these personal board URLs.

As described above, the board management information refers to information in which the shared board URL, the personal board URL, and the date and time are associated with each other. In this manner, in the service providing device 40, the URL of the shared board used for sharing by the attendees of the reserved meeting and the URL of the personal board used for each attendee of the meeting are managed in association with each other. The board management information does not necessarily have to include, for example, the date and time.

Referring back to FIG. 5, the check-in management unit 304 of the meeting reservation program 300 generates check-in information and stores the generated check-in information in the check-in information memory 310 (step S112). The check-in management unit 304 associates the shared board URL sent back from the service providing device 40 in step S107 with the meeting reservation number generated in step S108, so as to generate check-in information. The check-in information may be generated and stored after a result is sent back from the scheduler device 50 in step S114 described later.

An example of the check-in information generated in step S112 described above is illustrated in FIG. 9. FIG. 9 illustrates an example of check-in information 3000. The check-in information 3000 illustrated in FIG. 9 includes, as data items, the meeting reservation number, and the shared board URL.

In the data item “meeting reservation number,” the meeting reservation number generated in step S108 described above is set. In the data item “shared board URL,” the shared board URL sent back from the service providing device 40 in step S107 described above is set.

In the check-in information 3000 illustrated in FIG. 8, “12345” is set as the meeting reservation number, and “http://.../abc/share” is set as the shared board URL.

As described above, the check-in information refers to information in which a meeting reservation number and a shared board URL are associated with each other.

Referring back to FIG. 5, the request unit 302 of the meeting reservation program 300 sends a schedule request to the scheduler device 50 for each attendee of the newly reserved meeting (step S113). The schedule request includes the user identification information of the attendee of the meeting, the meeting information, the meeting reservation number, the shared board URL, and the personal board URL of the attendee.

For example, the attendees of the meeting here are “user A” and “user B.” In this case, the request unit 302 sends a schedule request including the user identification information of the user A, the meeting information, the meeting reservation number, the shared board URL, and the personal board URL of the user A to the scheduler device 50. The request unit 302 also sends a schedule request including the user identification information of the user B, the meeting information, the meeting reservation number, the shared board URL, and the personal board URL of the user B to the scheduler device 50.

Upon receiving the schedule request, the schedule management unit 502 of the scheduler program 500 updates the schedule information stored in the schedule information memory 520 with various types of information included in the schedule information (step S114). That is, the schedule management unit 502 specifies schedule information in which that user identification information is included among the schedule information stored in the schedule information memory 520. Then, the schedule management unit 502 updates the specified schedule information by using the meeting information, the meeting reservation number, the shared board URL, and the personal board URL. After the updating, the schedule management unit 502 sends an update result (a result) back to the meeting reservation device 30.

Here, an example of the updated schedule information is illustrated in FIG. 10. FIG. 10 illustrates an example of schedule information 4000. The schedule information 4000 illustrated in FIG. 10 includes, as data items, user identification information, year, month, and day, time, and registered content.

In the data item “user identification information,” user identification information for identifying a user of the scheduling service (for example, an e-mail address) is set.

In the data item “year, month, and day,” year, month, and day of the reserved meeting is set. The schedule information 4000 includes a plurality of records for each year, month, and day. In the data item “time,” the time of the reserved meeting is set. In the data item “ content,” contents of the reserved meeting (the title of meeting, the place, the attendees, the meeting reservation number, the shared board URL, the personal board URL, and so forth) are set.

The schedule information 4000 illustrated in FIG. 10 is, for example, updated schedule information of the user B (user identification information “userB@hogehoge.com”). In the schedule information 4000 illustrated in FIG. 10, the following registered contents are set with respect to the time “15:00-16:00” of date “2018/4/27.”

Title of meeting: Design meeting

Place: Meeting room A

Attendees: User A, User B

Meeting reservation number: 12345

Shared board URL: http://.../abc/share

Personal board URL: http://.../abc/userB

As described above, the updated schedule information includes the user identification information of the user of the scheduling service using this schedule information, year, month, and day of the reserved meeting, time of the meeting, and the contents of the meeting. In this manner, by using the web browser 100, the user of the scheduling service can confirm the registered contents (that is, for example, the title of meeting, the place, the attendees, the meeting reservation number, the shared board URL, and the personal board URL). FIG. 10 illustrates the schedule information 4000 of the user B as an example. However, if, for example, the attendees of the reserved meeting are the “user A” and the “user B,” the schedule information of user A is also updated. At this time, the personal board URL “http://.../abc/userA” of the user A is set as the registered contents of the schedule information of the user A. The meeting reservation number may be registered, for example, only in the schedule information of an attendee is a predetermined organizer among the attendees of the meeting.

As described above, in the meeting service system 1 according to the present embodiment, when the user of the terminal device 10 reserves a meeting by using the scheduling service, the shared board shared by the attendees of this meeting and a personal board used by each attendee are generated. Further, in the meeting service system 1 according to the present embodiment, the shared board URL and the personal board URL are registered with respect to the schedule information of each attendee. In this manner, each attendee can easily access the shared board and the personal board to be used in the meeting, and can manage the shared board and the personal board in association with each other on the scheduling service. Therefore, even after the meeting is over, for example, each attendee can easily recognize which shared board the note took by himself/herself on his/her personal board is associated with.

In the present embodiment, the shared board URL, the personal board URL, the meeting information, and the like are registered in the schedule information, but this configuration is not restrictive. The shared board URL, the personal board URL, the meeting information, and the like may be notified to the attendees of the reserved meeting by using, for example, an e-mail and a message service, such as a chat. The notification destination (for example, an e-mail address, and a user ID) when an e-mail or a message service is used may be stored, for example, in the meeting reservation device 30 in association with the user identification information of the scheduling service.

Especially if, for example, external scheduling services are to be used, some scheduling services only allow to register the same schedule for all attendees of the meeting. In this case, for example, since the shared board URL and the personal board URLs for all the attendees are registered for all the attendees of the meeting, each user's own personal board URL is known to other attendees. Therefore, in such a case, by making notification using an e-mail or a message service described above, it is possible to prevent the personal board URL from being known by other attendees.

The notification using an e-mail or a message service as described above may be performed, for example, together with a reservation completion notification of the meeting and a reminder notification of the meeting. Here, the meeting reservation completion notification is, for example, a notification of meeting reservation number. The reminder notification of the meeting is, for example, a message for confirming whether there is a change in the reservation contents of the meeting, or a URL for cancelling the reservation. The reminder notification is sent predetermined time before the start of the meeting (predetermined time before, such as one week, one day, or 15 minutes).

In the present embodiment, the shared board and the personal boards are generated (steps S107 and S110) when the meeting is reserved, but this configuration is not restrictive. For example, the shared board and the personal board may be generated at the timing, for example, when it is input that there is no change in the reservation content of the meeting in response to the reminder notification described above.

Further, when it is input that there is no change in the reservation content of the meeting in response to the reminder notification described above, the attendees of the meeting may be registered in the schedule information, a notification may be made by, for example, an e-mail and a message service, or the like.

### Meeting Start Process

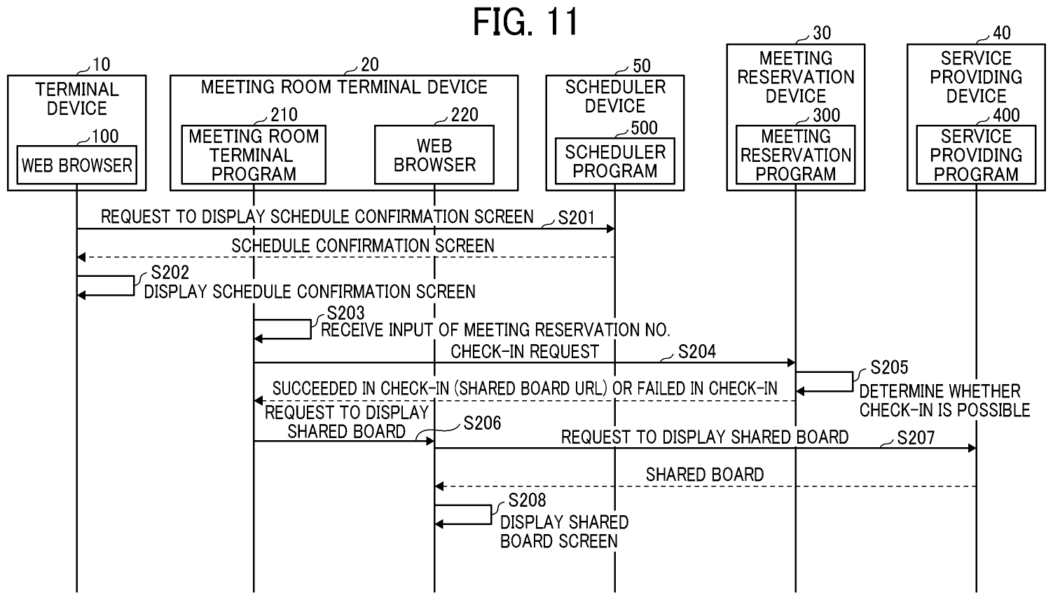

Hereinafter, a process for starting an electronic meeting by using the meeting service system 1 according to the present embodiment is described with reference to FIG. 11. FIG. 11 is a sequence diagram illustrating an example of a meeting start process according to the first embodiment.

First, the request unit 103 of the web browser 100 sends a request for displaying a schedule confirmation screen to the scheduler device 50 (step S201). The display request of the schedule confirmation screen is displayed when, for example, the user selects a proper schedule, and presses a link and the like for confirming the registered content of that schedule on the screen of the scheduling service displayed on the web browser 100. In this manner, the schedule confirmation screen (more accurately, web content for displaying the schedule confirmation screen) is sent back from the scheduler device 50. This schedule confirmation screen is generated based on the schedule information of the schedule selected by the user.

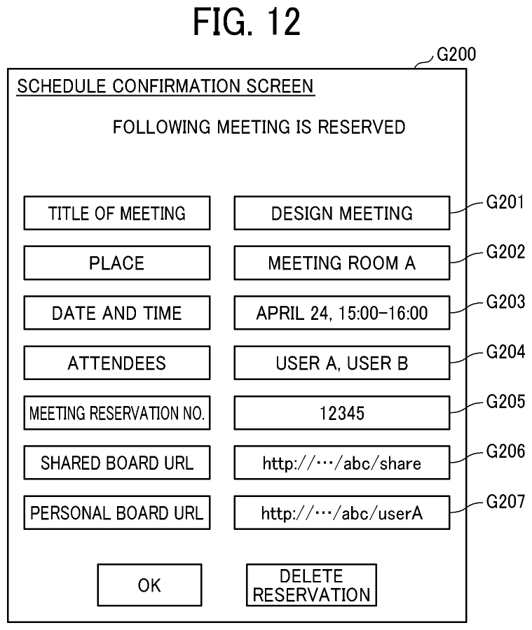

Upon receiving the schedule confirmation screen from the scheduler device 50, the display control unit 102 of the web browser 100 displays the schedule confirmation screen G200 illustrated, for example, in FIG. 12 (step S202). The schedule confirmation screen G200 illustrated in FIG. 12 is a screen for confirming the date, time, registered content, and the like of the schedule. The schedule confirmation screen G200 illustrated in FIG. 12 includes a meeting title display field G201, a place display field G202, a date and time display field G203, an attendee display field G204, a meeting reservation number display field G205, a shared board display field G206, and a personal board display field G207. With this configuration, the user can know the meeting reservation number, the shared board URL, his/her own personal board URL, and the like.

Here, for example, the user who confirmed the meeting reservation number on the schedule confirmation screen G200 illustrated in FIG. 12 inputs the meeting reservation number in a predetermined screen displayed on the meeting room terminal device 20 when starting the electronic meeting. Inputting the meeting reservation number is also called a check-in operation.

The input receiving unit 211 of the meeting room terminal program 210 receives the input of the meeting reservation number (step S203).

When the input receiving unit 211 receives the input of the meeting reservation number, the request unit 213 of the meeting room terminal program 210 sends a check-in request to the meeting reservation device 30 (step S204). The check-in request includes the meeting reservation number input in step S203 described above.

Upon receiving the check-in request, the check-in management unit 304 of the meeting reservation program 300 refers to the check-in information memory 310 and determine whether check-in is possible (step S205). In particular, the check-in management unit 304 determines whether check-in information in which the meeting reservation number included in the check-in request is set is stored in the check-in information memory 310.

If the check-in information is stored in the check-in information memory 310, the check-in management unit 304 sends back the information indicating that check-in is made successfully to the meeting room terminal device 20. At this time, the check-in management unit 304 also sends back the shared board URL included in the check-in information.

On the other hand, if the check-in information is not stored in the check-in information memory 310, the check-in management unit 304 sends back the information indicating that check-in is not made successfully to the meeting room terminal device 20. Hereinafter, description is continued on the assumption that the information indicating that check-in is made successfully is sent back to the meeting room terminal device 20.

Upon receiving the information indicating that check-in is made successfully, the request unit 213 of the meeting room terminal program 210 sends a shared board display request to the web browser 220 (step S206). The shared board display request includes the shared board URL sent back from the meeting reservation device 30.

The request unit 223 of the web browser 220 sends a shared board display request to the shared board URL (step S207). Then, the service providing device 40 sends back the shared board indicated by the shared board URL (more accurately, the web content for displaying the shared board).

When the shared board is sent back, the display control unit 222 of the web browser 220 displays the shared board screen (step S208).

As described above, in the meeting service system 1 according to the present embodiment, when the meeting reservation number is input in the meeting room terminal device 20, the shared board is displayed on the meeting room terminal device 20. This process starts the reserved electronic meeting. In FIG. 11, whether check-in is possible is determined based on whether check-in information including the meeting reservation number input in the meeting room terminal device 20 exists, the present disclosure is not limited to this configuration. In addition to this configuration, for example, whether the date and time of the reserved meeting has come (or it has become within predetermined time from the date) may be determined.

In the present embodiment, the meeting reservation number is input in the meeting room terminal device 20 to start the use of the electronic meeting, but the present disclosure is not limited to this configuration. For example, a predetermined button (such as a “meeting start” button or an “enter” button) displayed on the meeting room terminal device 20 may be simply pressed to start the use of the electronic start. Alternatively, for example, instead of the meeting reservation number, any identification information for identifying the reserved meeting may be input. In particular, when using an external service as a scheduling service, for example, identification information issued by this external service may be used. In this case, in response to the reservation of the meeting by the scheduling service, the meeting reservation device 30 needs to obtain identification information for identifying the meeting from the scheduling service.

### Meeting Attendance Process

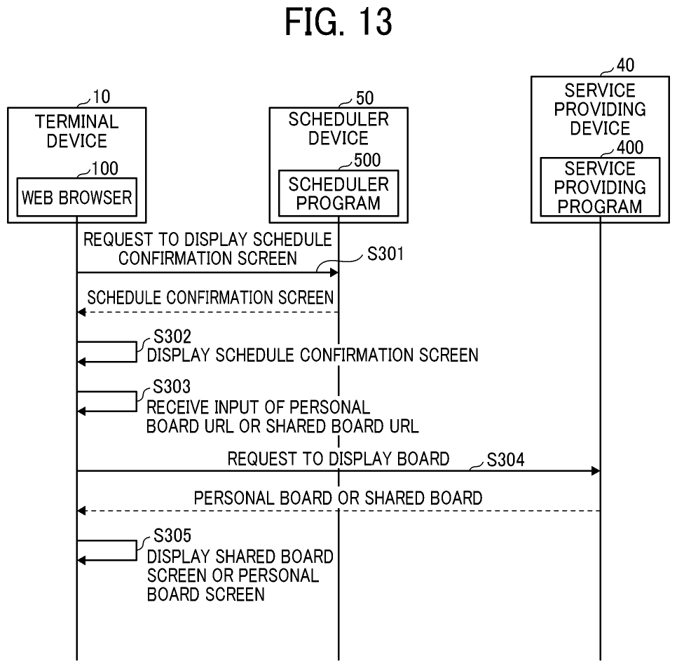

Hereinafter, a process in the case in which users are to attend the electronic meeting started by using the meeting service system 1 according to the present embodiment is described with reference to FIG. 13. FIG. 13 is a sequence diagram illustrating an example of a meeting attendance process according to the first embodiment.

First, the request unit 103 of the web browser 100 sends a request to display a schedule confirmation screen to the scheduler device 50 as in step S201 of FIG. 11 (step S301).

As in step S202 of FIG. 11, upon receiving the schedule confirmation screen from the scheduler device 50, the display control unit 102 of the web browser 100 displays the schedule confirmation screen G200 illustrated, for example, in FIG. 12 (step S302).

Here, for example, a user who confirms his/her personal board URL or shared board URL on the schedule confirmation screen G200 illustrated in FIG. 12 inputs his/her personal board URL or shared board URL in the web browser 100. The input receiving unit 101 of the web browser 100 receives input of the personal board URL or the shared board URL (step S303). Hereinafter, the description is continued on the assumption that the input receiving unit 101 of the web browser 100 has received input of the personal board URL.

The request unit 103 of the web browser 100 sends a board display request to the personal board URL (step S304). In this manner, the service providing device 40 sends back the personal board indicated by the personal board URL (more accurately, the web content for displaying the personal board). If input of the shared board URL is received in step S303 described above, the shared board indicated by the shared board URL is sent back from the service providing device 40.

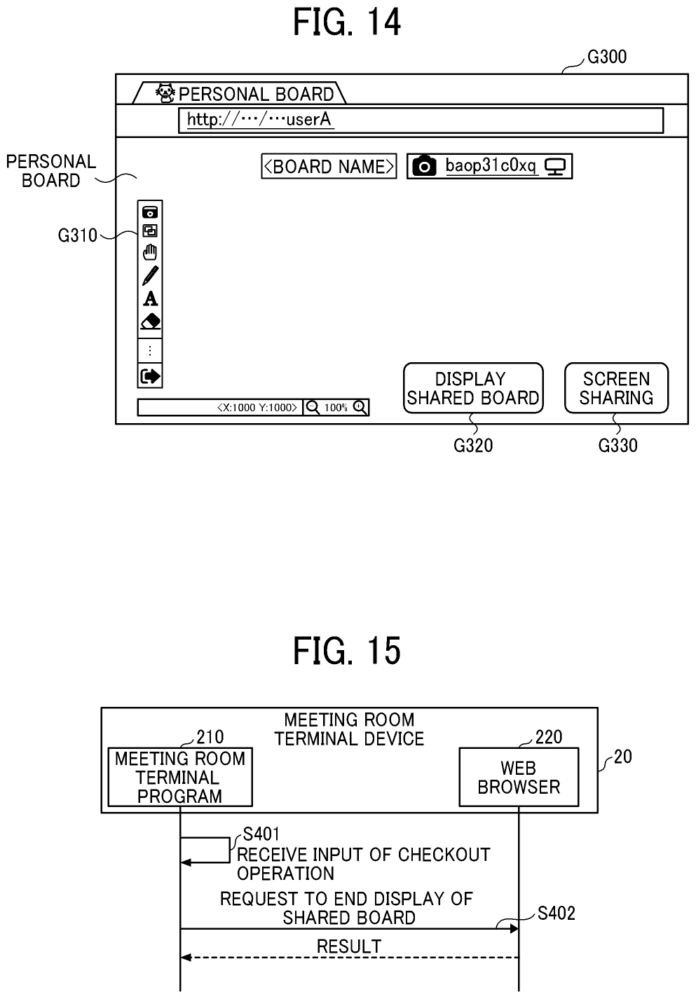

When the personal board is sent back, the display control unit 102 of the web browser 100 displays, for example, a personal board screen G300 illustrated in FIG. 14 (step S305). A personal board is displayed on the personal board screen G300 illustrated in FIG. 14. Thus, the user of the terminal device 10 can conduct an electronic meeting in which the personal board is used.

The personal board screen G300 illustrated in FIG. 14 includes a drawing tool selection field G310. The user can draw an arbitrary character, a figure, or the like on the personal board by selecting a desired drawing tool (for example, a pen and character input) in the drawing tool selection field G310. Further, an image and the like may be attached to a personal board.

The personal board screen G300 illustrated in FIG. 14 includes a shared board display button G320 and a screen sharing button G330. By pressing the shared board display button G320, the user can cause the shared board to be displayed. The shared board displayed at this time is a shared board associated with the currently displayed personal board. That is, the shared board displayed at this time is a shared board of the shared board URL associated with the personal board URL of the personal board in the board management information 2000 illustrated in FIG. 8.

Also, by pressing the screen sharing button G330, the user can share the screen content displayed on his/her terminal device 10 with another terminal device 10.

As described above, in the meeting service system 1 according to the present embodiment, by inputting the personal board URL and the shared board URL registered in his/her schedule in the web browser 100, the user of each terminal device 10 can attend the electronic meeting. Even if each user closes the display of the personal board on the web browser 100 in the middle of the electronic meeting, for example, by inputting the personal board URL again in the web browser 100, the user can cause his/her personal board to be displayed again.

### Meeting End Process

Hereinafter, a process for ending an electronic meeting by using the meeting service system 1 according to the present embodiment is described with reference to FIG. 15. FIG. 15 is a sequence diagram illustrating an example of a meeting end process according to the first embodiment.

The input receiving unit 211 of the meeting room terminal program 210 receives input of a check-out operation (step S401). By pressing a button or the like for checking out, for example, the user can perform a check-out operation.

When the input receiving unit 211 receives input of a check-out operation, the request unit 213 of the meeting room terminal program 210 sends a shared board display end request to the web browser 220 (step S402). With this process, display of the shared board is ended.

As described above, in the meeting service system 1 according to the present embodiment, when the check-out operation is input by the meeting room terminal device 20, the display of the shared board ends. Then, the electronic meeting is ended. Note that, when, for example, the date and time of the reserved meeting has passed, the electronic meeting may be ended.

In the meeting service system 1 according to the present embodiment, the personal board and the shared board are not deleted even when the electronic meeting is ended. For this reason, even after the electronic meeting ends, by inputting the personal board URL or the shared board URL in the web browser 100 or the like, the personal board or the shared board can be displayed.

### Second Embodiment

Next, a second embodiment is described. In the second embodiment, regarding personal boards generated when a meeting is reserved, a case in which personal boards which have not been accessed are deleted at the end of the meeting is described. In this manner, unused personal boards are deleted to release a storage area of the board memory 410. In the second embodiment, differences from the first embodiment are mainly described, and the same components as those of the first embodiment are not described.

### Functional Configuration

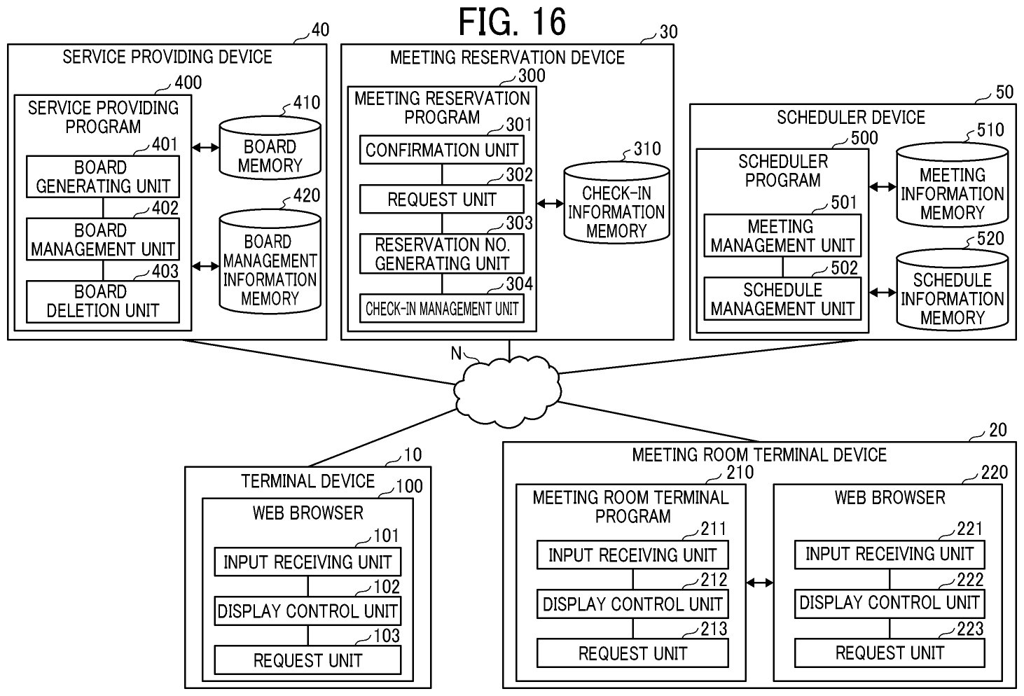

First, a functional configuration of the meeting service system 1 according to the present embodiment is described with reference to FIG. 16. FIG. 16 illustrates an example of a functional configuration of the meeting service system 1 according to the second embodiment. The functional configurations of the terminal devices 10, the meeting room terminal device 20, the meeting reservation device 30, and the scheduler device 50 are the same as those in the first embodiment, and thus are not described.

### Service Providing Device

As illustrated in FIG. 16, the service providing device 40 according to the present embodiment further includes a board deletion unit 403 in addition to the functional configurations of the first embodiment. The board deletion unit 403 is implemented by a process that the service providing program 400 causes the CPU to execute.

Among the personal boards stored in the board memory 410, the board deletion unit 403 deletes, at the end of the meeting, personal boards that have not been accessed. Therefore, the personal boards unused in the electronic meeting can be deleted from the board memory 410.

### Details of Process

Next, details of the process of the meeting service system 1 according to the present embodiment are described.

### Meeting Reservation Process

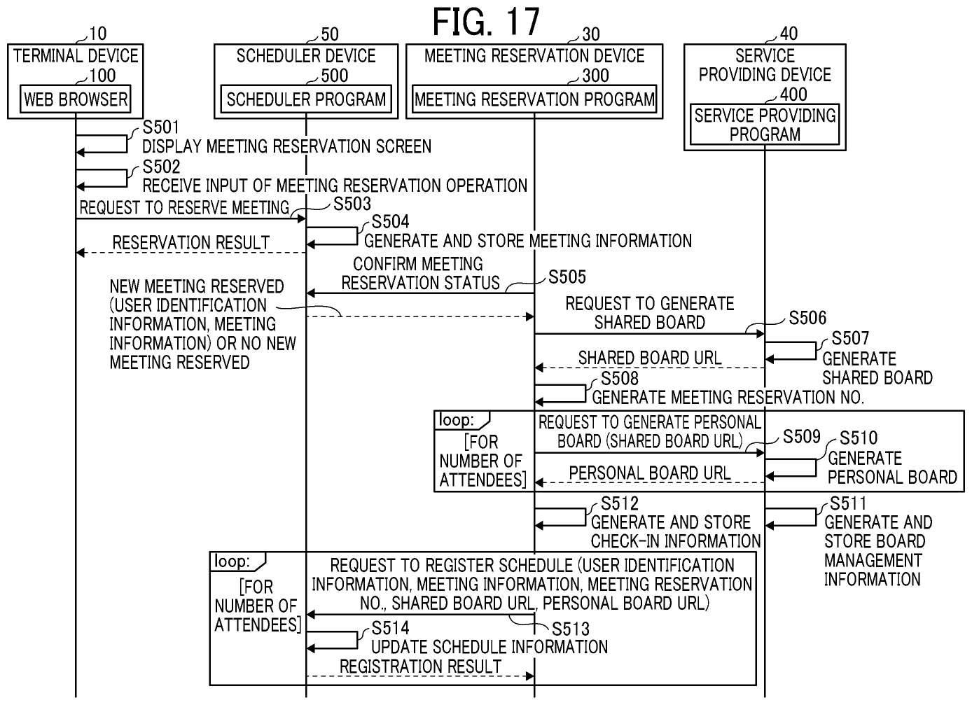

Hereinafter, a process for reserving an electronic meeting by using the meeting service system 1 according to the present embodiment is described with reference to FIG. 17. FIG. 17 is a sequence diagram illustrating an example of the meeting reservation process according to the second embodiment. Steps S501 to S510 and steps S512 to S514 in FIG. 17 are the same as steps S101 to S110 and steps S112 to S114 of FIG. 5, respectively, and thus are not described.

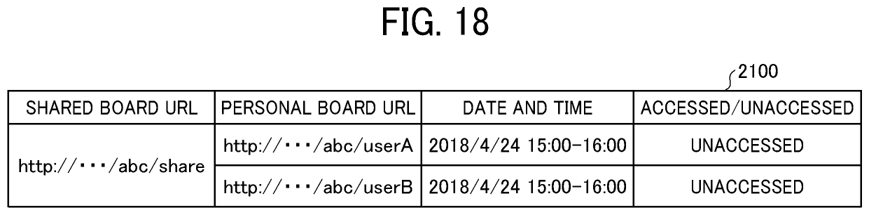

Following step S510, after generating the board management info' nation, the board management unit 402 of the service providing program 400 stores the generated board management information in the board management information memory 420 (step S511). In the present embodiment, for example, board management information 2100 illustrated in FIG. 18 is generated. FIG. 18 illustrates an example of the board management information 2100.

The board management information 2100 illustrated in FIG. 18 further includes access records regarding data items included in the board management information 2000 of the first embodiment. In the data item “accessed/unaccessed,” whether the personal board URL has been accessed or not is set. In this data item “accessed/unaccessed,” “unaccessed” indicating that the personal board URL is unaccessed is set as an initial value.

As described above, the board management information according to the present embodiment refers to information in which whether accessed/unaccessed is associated with the personal board URL. In this manner, accessed/unaccessed with respect to each personal board is managed.

As described above, in the meeting service system 1 according to the present embodiment, board management information including data items for managing accessed/unaccessed with respect to the personal board is generated. As in the first embodiment, by using an e-mail message service or the like, a shared board URL, a personal board URL, meeting information, and the like may be notified to attendees of the reserved meeting. Further, as in the first embodiment, timing at which the shared board and the personal boards are generated is not limited to when the meeting is reserved.

### Meeting Attendance Process

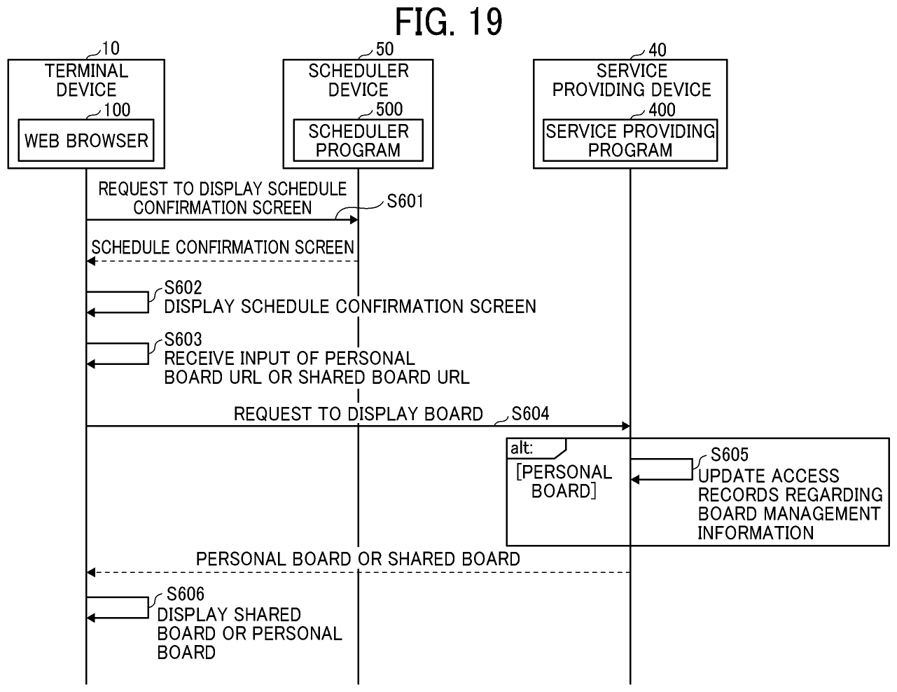

Hereinafter, a process for starting an electronic meeting by using the meeting service system 1 according to the present embodiment is described with reference to FIG. 19. FIG. 19 is a sequence diagram illustrating an example of a meeting attendance process according to the second embodiment. Steps S601 to S603 and step S606 in FIG. 19 are the same as steps S301 to S303 and step S305 in FIG. 13, respectively, and thus are not described. Further, in step S603 in FIG. 19, it is assumed that the input receiving unit 101 of the web browser 100 has received input of a personal board URL.

Subsequent to step S603, the request unit 103 of the web browser 100 sends a board display request to the personal board URL (step S604).

In the board management information stored in the board management information memory 420, the board management unit 402 of the service providing program 400 updates accessed/unaccessed corresponding to the personal board URL to “accessed” (step S605). This process manages that the personal board of the personal board URL has been accessed.

Then, the service providing program 400 sends back, to the terminal device 10, the personal board indicated by the personal board URL (more accurately, web content for displaying the personal board). If input of the shared board URL is received in step S603, step S605 is not executed and the shared board indicated by the shared board URL is sent back to the terminal device 10.

As described above, in the meeting service system 1 according to the present embodiment, if the personal board has been accessed, the access record of the URL of the personal board is updated to “accessed” in the board management information. This process manages that the personal board has been accessed.

### Meeting End Process

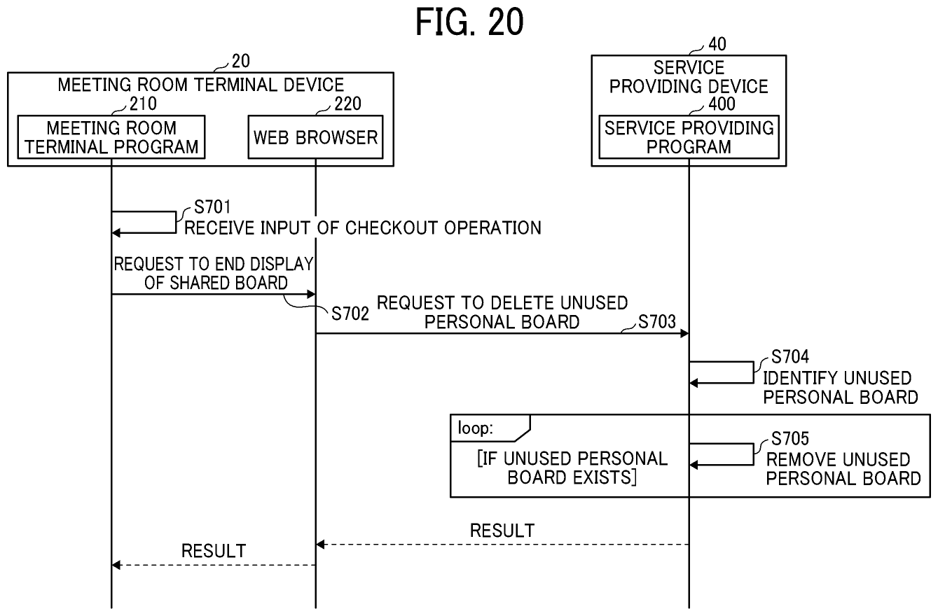

Hereinafter, a process for ending an electronic meeting by using the meeting service system 1 according to the present embodiment is described with reference to FIG. 20. FIG. 20 is a sequence diagram illustrating an example of a meeting end process according to the second embodiment. Step S701 in FIG. 20 is the same as step S401 in FIG. 15 and thus is not described.

Following step S701, when the input receiving unit 211 receives input of a check-out operation, the request unit 213 of the meeting room terminal program 210 sends a shared board display end request to the web browser 220 (step S702).

Upon receiving the shared board display end request, the request unit 223 of the web browser 220 sends an unused personal board deletion request to the service providing device 40 (step S703).

The board deletion unit 403 of the service providing program 400 refers to the board management information stored in the board management information memory 420, and identifies unused personal boards (step S704). That is, the board deletion unit 403 specifies, in the board management information, personal board URLs for which accessed/unaccessed is “unaccessed.”

If one or more personal board URLs are specified in step S704, the board deletion unit 403 of the service providing program 400 deletes the personal boards of the specified personal board URLs from the board memory 410 (step S705). In this manner, unused personal boards are deleted from the board memory 410.

As described above, the meeting service system 1 according to the present embodiment refers to the board management information and identifies unused personal boards, and then deletes the identified personal boards. Thus, unused personal boards can be deleted from the board memory 410.

### Third Embodiment

Next, a third embodiment is described. In the third embodiment, a case in which personal boards are not generated at the time of reservation of a meeting but are generated in accordance with an attendance status of users is described. Therefore, since the personal boards corresponding to the number of users who attend the meeting are generated, generation of unnecessary personal boards is avoided.

In the third embodiment, differences from the first embodiment are mainly described, and the same components as those of the first embodiment are not described.

### Functional Configuration

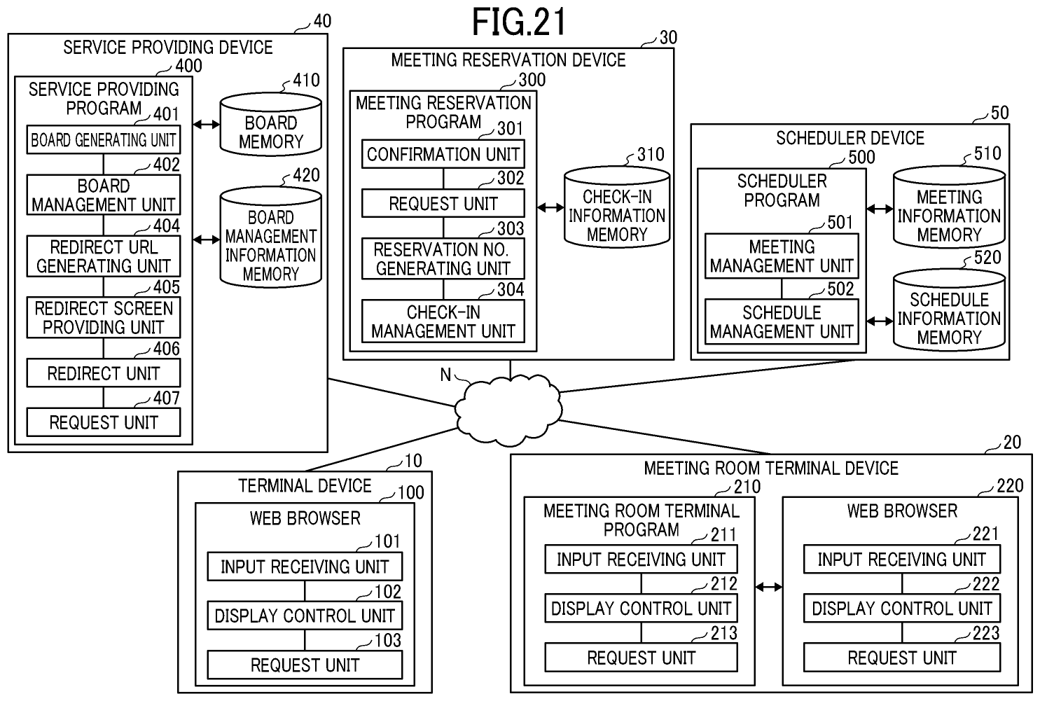

First, a functional configuration of the meeting service system 1 according to the present embodiment is described with reference to FIG. 21. FIG. 21 illustrates an example of a functional configuration of the meeting service system 1 according to the third embodiment. The functional configurations of the terminal devices 10, the meeting room terminal device 20, the meeting reservation device 30, and the scheduler device 50 are the same as those in the first embodiment, and thus are not described.

### Service Providing Device

As illustrated in FIG. 21, the service providing device 40 according to the present embodiment further includes a redirect URL generating unit 404, a redirect screen providing unit 405, a redirect unit 406, and a request unit 407 in addition to the functional configurations of the first embodiment. These units are implemented by processes that the service providing program 400 causes the CPU to execute.

The redirect URL generating unit 404 generates a URL for a user attending the electronic meeting to generate an own personal board (hereinafter also referred to as a “personal board redirect URL”). The user of the terminal device 10 uses the web browser 100 and accesses the personal board redirect URL, whereby the user can generate an own personal board.

When the terminal device 10 accesses the personal board redirect URL, the redirect screen providing unit 405 provides a redirect screen to the terminal device 10. The redirect screen refers to a screen (a web page) displayed on the terminal device 10 until the personal board of the user of the terminal device 10 is generated and redirected to a redirect destination URL. Here, the redirect destination URL is the personal board URL of the user of the terminal device 10.

The redirect unit 406 sends, to the terminal device 10, an instruction for redirecting to the redirect destination URL (a redirect instruction). In this manner, the personal board screen of the user is displayed on the web browser 100 of the terminal device 10.

In response to a request from the terminal device 10, the request unit 407 sends a schedule request to the scheduler device 50.

### Details of Process

Next, details of the process of the meeting service system 1 according to the present embodiment are described.

### Meeting Reservation Process

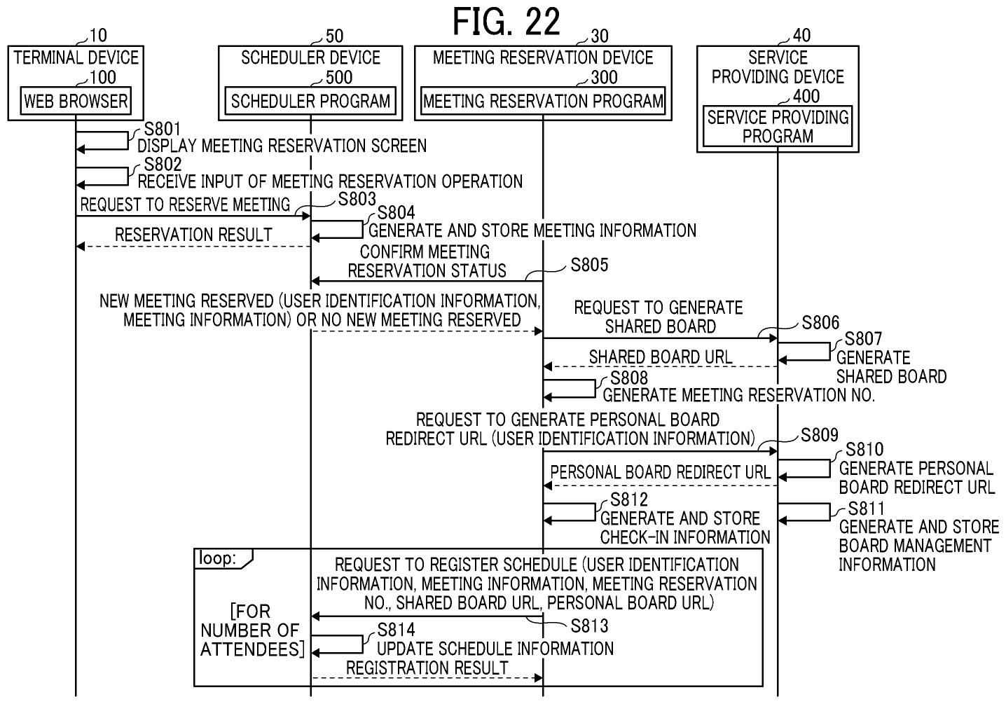

Hereinafter, a process for reserving an electronic meeting by using the meeting service system 1 according to the present embodiment is described with reference to FIG. 22. FIG. 22 is a sequence diagram illustrating an example of the meeting reservation process according to the third embodiment. Steps S801 to S808 and step S812 in FIG. 22 are the same as steps S101 to S108 and step S112 in FIG. 5, respectively, and thus are not described.

Subsequent to step S808, the request unit 302 of the meeting reservation program 300 sends a personal board redirect URL generation request (step S809). The personal board redirect URL generation request includes user identification information (that is, user identification information of the user attending the reserved meeting) sent back from the scheduler device 50 in step S805. However, the personal board redirect URL generation request does not necessarily have to include user identification information. As described later, when a personal board redirect URL is to be generated for each user identification information, the personal board redirect URL generation request includes user identification information.

Upon receiving the personal board redirect URL generation request, the redirect URL generating unit 404 of the service providing program 400 generates a personal board redirect URL (step S810). Then, the service providing program 400 sends back the personal board redirect URL to the meeting reservation device 30.

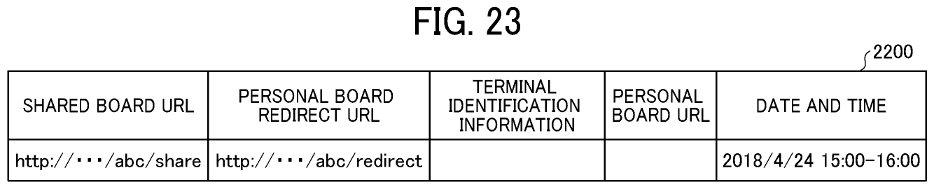

Next, after generating the board management information, the board management unit 402 of the service providing program 400 stores the generated board management information in the board management information memory 420 (step S811). In the present embodiment, for example, board management information 2200 illustrated in FIG. 23 is generated. FIG. 23 illustrates an example of the board management information 2200.

The board management information 2200 illustrated in FIG. 23 further includes a personal board redirect URL and terminal identification information in addition to the data items included in the board management information 2000 of the first embodiment.

In the data item “personal board redirect URL,” the personal board redirect URL generated in step S810 describe above is set. In the data item “terminal identification information,” identification information for identifying the terminal device 10 (for example, Internet Protocol (IP) address) is set when the personal board has been generated according to the access to the personal board redirect URL.

In the board management information 2200 illustrated in FIG. 23, “http://.../abc/redirect” is set as the personal board redirect URL. In the data items “terminal identification information” and “personal board URL,” no value is set (or a null value is set) in step S811 described above.

As described above, the board management information according to the present embodiment refers to information including the personal board redirect URL, and in which the terminal identification information and the personal board URL are associated with each other. As described later, if the personal board is generated in response to the access to the personal board redirect URL, the terminal identification information and the personal board URL are set (updated).

Subsequent to step S812, the request unit 302 of the meeting reservation program 300 sends a schedule request to the scheduler device 50 for each attendee of the newly reserved meeting (step S813). The schedule request according to the present embodiment includes the user identification information of the attendee of the meeting, the meeting information, the meeting reservation number, the shared board URL, and the personal board redirect URL.

Upon receiving the schedule request, the schedule management unit 502 of the scheduler program 500 updates the schedule information stored in the schedule information memory 520 with various types of information included in the schedule information (step S814). That is, the schedule management unit 502 specifies schedule information in which that user identification information is included among the schedule information stored in the schedule information memory 520. Then, the schedule management unit 502 updates the specified schedule information by using the meeting information, the meeting reservation number, the shared board URL, and the personal board redirect URL. After the updating, the schedule management unit 502 sends an update result back to the meeting reservation device 30. As described above, in the present embodiment, the personal board redirect URL is registered in the schedule instead of the personal board URL.

As described above, in the meeting service system 1 according to the present embodiment, when the user of the terminal device 10 reserves a meeting by using the scheduling service, the personal board redirect URL is generated. Then, in the meeting service system 1 according to the present embodiment, this personal board redirect URL is registered in the schedule of each attendee.

The same personal board redirect URLs are generated to the attendees in step S810 described above, however, this configuration is not restrictive. For example, a personal board redirect URL may be generated for each piece of user identification information. In this case, in step S813 described above, the personal board redirect URL corresponding to the user identification information may be included in the schedule request for each piece of user identification information. In this manner, a personal board redirect URL different for each attendee is registered in the schedule. As in the first embodiment, by using an e-mail message service or the like, a shared board URL, a personal board URL, meeting information, and the like may be notified to attendees of the reserved meeting. Further, as in the first embodiment, timing at which the shared board is generated is not limited to when the meeting is reserved.

### Meeting Attendance Process

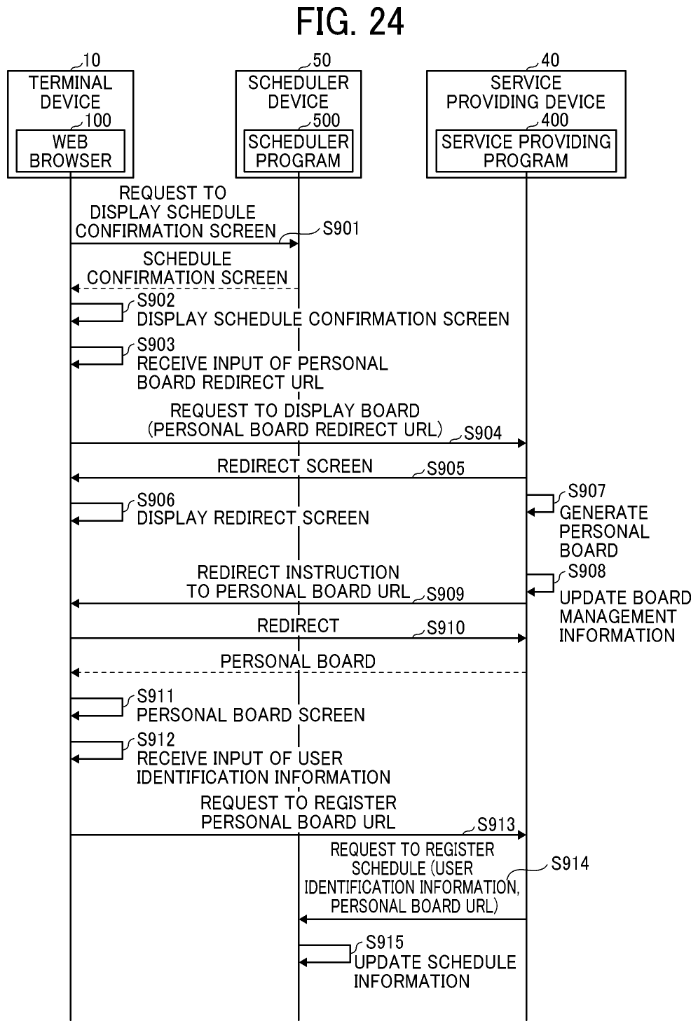

Hereinafter, a process in the case in which users are to attend the electronic meeting started by using the meeting service system 1 according to the present embodiment is described with reference to FIG. 24. FIG. 24 is a sequence diagram illustrating an example of a meeting attendance process according to the third embodiment.

First, the request unit 103 of the web browser 100 sends a request to display a schedule confirmation screen to the scheduler device 50 as in step S201 of FIG. 11 (step S901).

As in step S202 of FIG. 11, upon receiving the schedule confirmation screen from the scheduler device 50, the display control unit 102 of the web browser 100 displays the schedule confirmation screen (step S902). Here, on this schedule confirmation screen, a personal board redirect URL is displayed instead of a personal board URL.

Here, the user who has confirmed the personal board redirect URL on the schedule confirmation screen displayed in step S902 described above inputs the personal board redirect URL in the web browser 100. The input receiving unit 101 of the web browser 100 receives input of the personal board redirect URL (step S903).

The request unit 103 of the web browser 100 sends a board display request to the personal board redirect URL (step S904).

Upon receiving the above-described board display request, the redirect screen providing unit 405 of the service providing program 400 sends a redirect screen (more accurately, web content for displaying a redirect screen) (step S905).

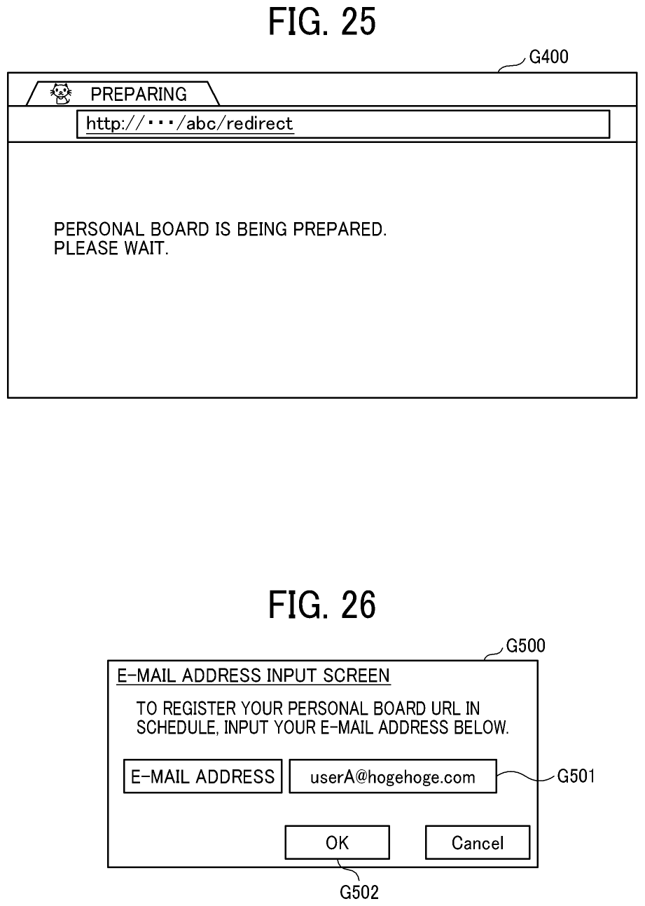

Upon receiving the redirect screen, the display control unit 102 of the web browser 100 displays a redirect screen G400 illustrated in FIG. 25, for example (step S906). The redirect screen G400 illustrated in FIG. 25 is displayed on the terminal device 10 until redirection to the redirect destination URL is completed. This is because it may take a certain time to generate a personal board and the like. If it takes little time to generate a personal board, the above-described redirect screen G400 does not necessarily have to be displayed on the terminal device 10.

The board generating unit 401 of the service providing program 400 generates a personal board to be used by the user of the terminal device 10 that is a request source of the board display request received in step S904 described above (step S907).

Next, the board management unit 402 of the service providing program 400 updates the board management information stored in the board management information memory 420 (step S908). That is, the board management unit 402 manages, for example, the personal board URL of the personal board generated in step S907 (and the terminal identification information of the terminal device 10 as the request source of the board display request in step S904). Correspond to the shared board URL in the information. In this manner, in the board management information, the personal board URL (and the terminal identification information) and the user identification information are managed in association with each other.

The board display request in step S904 described above may include user identification information. Therefore, in the board management information, the user identification information may also be associated with the personal board URL, or the like. In this case, input of the user identification information in step S912 described later is unnecessary.

Next, the redirect unit 406 of the service providing program 400 sends a redirect instruction to the terminal device 10 with the URL of the personal board (the personal board URL) generated in step S907 described above as a redirect destination (step S909).

The request unit 103 of the web browser 100 performs redirection to the personal board URL (step S910). In this manner, the personal board indicated by the personal board URL is sent back from the service providing device 40.

When the personal board is sent back, the display control unit 102 of the web browser 100 displays the personal board screen (step S911) as in step S305 of FIG. 13. Thus, the user can attend the electronic meeting in which the personal board is used.

Here, by pressing a predetermined button or the like on the personal board screen, the user can cause, for example, an e-mail address input screen G500 illustrated in FIG. 26 to be displayed on the web browser 100. The e-mail address input screen G500 illustrated in FIG. 26 is a screen on which an e-mail address (user identification information) for registering the personal board URL is input in the schedule. The user inputs an e-mail address (user identification information) in the e-mail address input field G501, and then presses an OK button G502. In this manner, the user can input user identification information. Hereinafter, description is continued on the assumption that the user identification information has been input by the user.

The input receiving unit 101 of the web browser 100 receives input of the user identification information (step S912).

When the input receiving unit 101 receives input of the user identification information, the request unit 103 of the web browser 100 sends a personal board URL request to the service providing device 40 (step S913). The personal board URL request includes the user identification information. At this time, the service providing device 40 may associate, in the board management information, the user identification information with the personal board URL of the personal board displayed by the terminal device 10 which is the request source of the personal board URL request.

Upon receiving the personal board URL request, the request unit 407 of the service providing program 400 sends a schedule request to the scheduler device 50 (step S914). The schedule request includes user identification information and a personal board URL.

Upon receiving the schedule request, the schedule management unit 502 of the scheduler program 500 updates the schedule information stored in the schedule information memory 520 with various types of information included in the schedule information (step S915). That is, the schedule management unit 502 specifies schedule information in which that user identification information is included among the schedule information stored in the schedule information memory 520. Then, the schedule management unit 502 updates the specified schedule information by using the personal board URL. In this manner, the personal board URL is registered in the schedule of the user identified by the user identification information.

As described above, in the meeting service system 1 according to the present embodiment, by inputting the personal board redirect URL in the web browser 100, the user of each terminal device 10 can generate and display a personal board. With this configuration, in the meeting service system 1 according to the present embodiment, only the personal boards of the users who actually attend the electronic meeting are generated, and therefore unnecessary personal boards may not be deleted, for example.

In the present embodiment, the user identification information is input in step S912 described above. However, when the personal board redirect destination URL is generated for each user, for example, the user identification information does not necessarily have to be input. In this case, for example, in step S811 described above, board management information in which the user identification information is associated with the personal board redirect destination URL of the user identified by the user identification information is generated. Then, when generating a personal board in step S907 described above, user identification information is specified from the personal board redirect destination URL. Therefore, the service providing program 400 may make a schedule request in step S914 described above by using the specified user identification information.

### Fourth Embodiment

Next, a fourth embodiment is described. In the fourth embodiment, a case in which use of an electronic meeting is started without reserving a meeting is described.

In the fourth embodiment, differences from the third embodiment are mainly described, and the same components as those of the third embodiment are not described.

### Details of Process

Next, details of the process of the meeting service system 1 according to the present embodiment are described. In the present embodiment, the meeting reservation process is not performed.

### Meeting Start Process

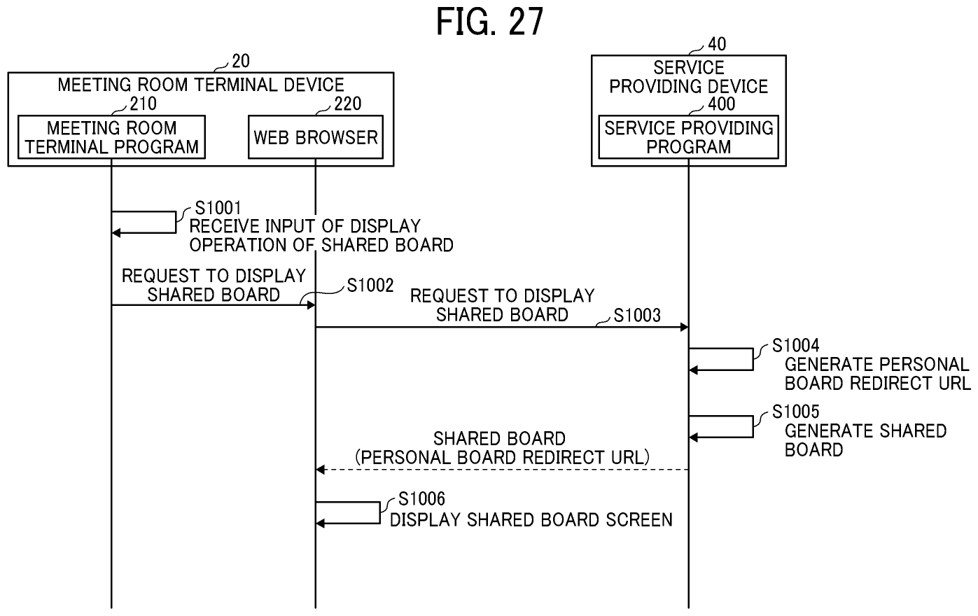

Hereinafter, a process for starting an electronic meeting by using the meeting service system 1 according to the present embodiment is described with reference to FIG. 27. FIG. 27 is a sequence diagram illustrating an example of a meeting start process according to the fourth embodiment.

The user uses the meeting room terminal device 20 to perform an operation to display the shared board (a shared board display operation). Then, the input receiving unit 211 of the meeting room terminal program 210 receives input of the shared board display operation (step S1001).

When the input receiving unit 211 receives input of the shared board display operation, the request unit 213 of the meeting room terminal program 210 sends a shared board display request to the web browser 220 (step S1002).

Next, the request unit 223 of the web browser 220 sends a shared board display request to the service providing device 40 (step S1003).

Upon receiving the shared board display request, the redirect URL generating unit 404 of the service providing program 400 generates a personal board redirect URL (step S1004).

Next, the board generating unit 401 of the service providing program 400 generates a shared board (step S1005). At this time, the board generating unit 401 generates a shared board on which the personal board redirect URL generated in step S1004 described above is displayed.

Then, the board generating unit 401 sends the shared board URL back to the meeting reservation device 30. The shared board is stored in the board memory 410.

When the shared board is sent back, the display control unit 222 of the web browser 220 displays the shared board screen (step S1006). At this time, the personal board redirect URL is displayed on the shared board screen. In this manner, when the user inputs a personal board redirect URL in the web browser 100, the personal board of that user is generated, and the personal board screen is displayed. After the personal board screen is displayed, the shared board URL and the personal board URL can be registered in the schedule information, as in the processes of steps S912 to S915 in FIG. 24. In this case, in step S914, a schedule request including the shared board URL in addition to the personal board URL is sent to the scheduler device 50.

As described above, in the meeting service system 1 according to the present embodiment, the shared board screen including the personal board redirect URL is displayed on the meeting room terminal device 20. Therefore, a user who wants to attend the meeting inputs the personal board redirect destination URL in the web browser 100 of his/her terminal device 10, whereby the user can generate his/her personal board and attend the meeting.

### Meeting Attendance Process

The meeting attendance process according to the present embodiment is the same as the meeting attendance process (FIG. 24) according to the third embodiment except that step S908 in FIG. 24 is not executed. In the meeting attendance process according to the present embodiment, input of the user identification information in step S912 in FIG. 24 is necessary to perform schedule.

### Fifth Embodiment

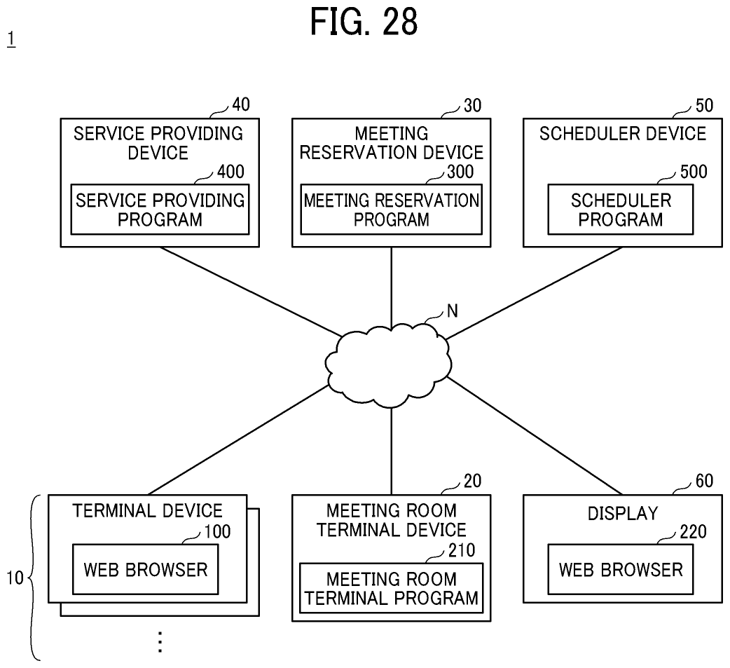

Next, a fifth embodiment is described. As the fifth embodiment, a configuration of the meeting service system 1 illustrated in FIG. 28 is also employable. That is, the meeting service system 1 according to the fifth embodiment includes the meeting room terminal device 20 in which the meeting room terminal program 210 is installed, and a display 60 in which the web browser 220 is installed. As described above, in the meeting room terminal device 20 according to the fifth embodiment, the meeting room terminal device 20 in which the meeting room terminal program 210 is installed and the display 60 in which the web browser 220 is installed may be separated from each other. In this case, for example, the shared board URL is sent from the meeting room terminal device 20 to the display 60 after step S205 of FIG. 11.

### Sixth Embodiment

Next, a sixth embodiment is described. In the sixth embodiment, a case in which a screen to be shared by attendees of a meeting is assumed as shared content (hereinafter, also referred to as a “shared screen”), and attendees (accurately, prospective attendees) are reminded before a predetermined time of the date and time at which the meeting is to be held is described.

In the sixth embodiment, differences from the first embodiment are mainly described, and the same components as those of the first embodiment are not described.

### Outline of Generation of Shared Screen and Personal Boards

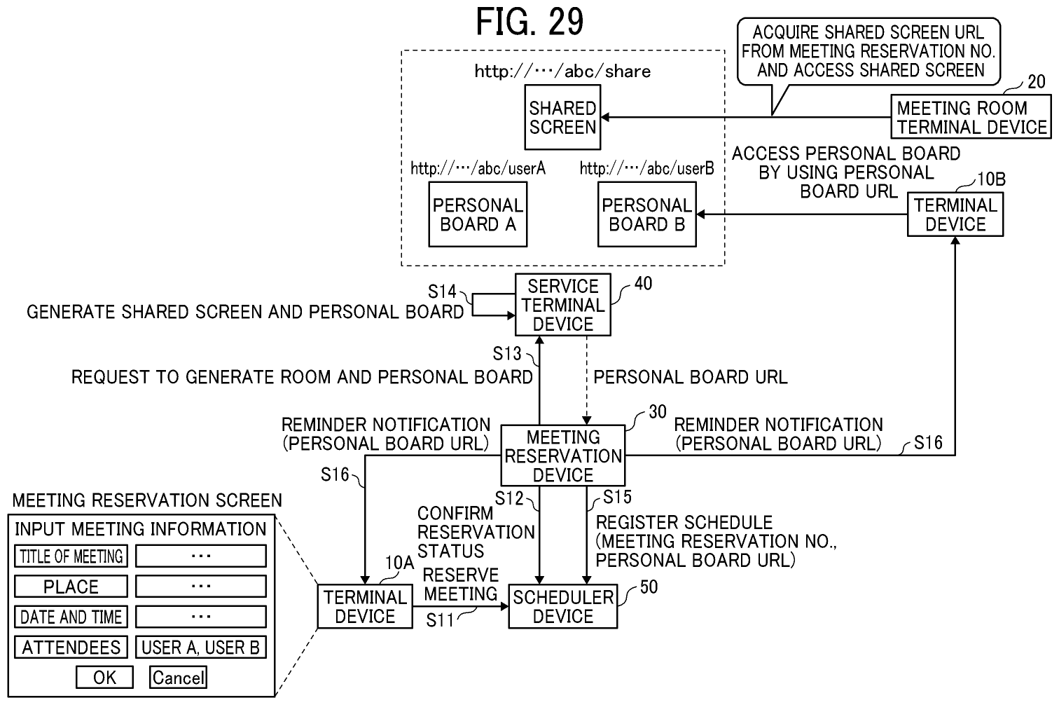

Here, as an example, an outline of a case in which a user of the terminal device 10A reserves a meeting by using the scheduling service, and a shared screen and personal boards of this meeting are generated is described with reference to FIG. 29. FIG. 29 illustrates an example of an outline of generation of a shared screen and personal boards.

S11) As in S1 of FIG. 2, the user A of the terminal device 10A reserves a meeting on the meeting reservation screen displayed on the web browser 100A.

S12) As in S2 of FIG. 2, the meeting reservation program 300 of the meeting reservation device 30 confirms the meeting reservation status in the scheduling service.

S13) When it is confirmed that a reservation for a new meeting has been made, the meeting reservation program 300 of the meeting reservation device 30 requests the service providing device 40 to generate a room and a personal board. The room is a virtual meeting room, and when a room is generated, a shared screen is generated (that is, a shared screen corresponds to a virtual whiteboard or a virtual monitor (display) installed in a virtual meeting room).

At this time, as in S3 of FIG. 2, the meeting reservation program 300 requests generation of a personal board for each attendee of the reserved meeting (in the example illustrated in FIG. 29, the number of attendees is two: “user A” and “user B”).

S14) In response to a request from the meeting reservation device 30, the service providing program 400 of the service providing device 40 generates a shared screen and a personal board. In this manner, a shared screen and a personal board for each attendee of the reserved meeting (in the example illustrated in FIG. 29, “personal board A” for the user A and “personal board B” for the user B) are generated.

Then, the service providing program 400 of the service providing device 40 sends the URL for accessing the shared screen and the personal board URL back to the meeting reservation device 30. Hereinafter, the URL for accessing the shared screen is also referred to as a “shared screen URL.”

S15) The meeting reservation program 300 of the meeting reservation device 30 registers the “meeting reservation number,” the “shared screen URL,” and the “personal board URL” for accessing the personal board of the attendee with respect to the schedule of the attendee of the reserved meeting.

S16) The meeting reservation program 300 of the meeting reservation device 30 sends a reminder notification to the terminal device 10 of the attendee of the meeting when it becomes predetermined time before the date and time of the reserved meeting (for example, one week, three days, one day, 30 minutes, or 15 minutes). The reminder notification is a notification for reminding the date and time when the meeting is held, and includes the personal board URL of the personal board of the attendee who uses the terminal device 10. In the example illustrated in FIG. 29, the meeting reservation program 300 sends a reminder notification including the personal board URL of the personal board A to the terminal device 10A, and sends a reminder notification including the personal board URL of the personal board B to the terminal device 10B.

The meeting reservation program 300 may send the reminder notification by using an e-mail, or by using a message service, such as a chat. In the present embodiment, as an example, it is assumed that a reminder notification is sent by using an e-mail.

Note that the meeting reservation program 300 may send a reminder notification to the terminal devices 10 of all the attendees of the meeting (the user A and the user B in the example illustrated in FIG. 29), or may send a reminder notification only to a terminal device 10 of a meeting organizer (the user A in the example illustrated in FIG. 29). Alternatively, the meeting reservation program 300 may send a reminder notification only to a terminal device 10 of an attendee selected at the meeting reservation among the attendees of the meeting.

In this manner, when a meeting is reserved, a meeting reservation number, a shared screen URL, and a personal board URL of a personal board of each user are registered in the schedule of each attendee of the meeting. In this manner, for example, when starting a reserved meeting, the user A inputs the meeting reservation number in the meeting room terminal device 20 and acquires the shared screen URL, so as to cause the shared screen to be displayed on the web browser 220 of the meeting room terminal device 20. However, the shared screen on the web browser 220 of the meeting room terminal device 20 may not be displayed. The shared screen does not necessarily have to be displayed, or, for example, the shared board may be displayed as in the first embodiment. Especially when, for example, the meeting room terminal device 20 is a small tablet terminal having a small monitor (display), the shared screen is not displayed in many cases.

Further, the user A and the user B can use the web browser 100 of their own terminal devices 10 to access the shared screen in addition to their own personal boards.

As described above, in the present embodiment, by registering the meeting reservation number, the shared screen URL, and the personal board URL in the schedule of each attendee of the meeting, each attendee can manage the shared screen and the personal board in association with each other.

### Functional Configuration

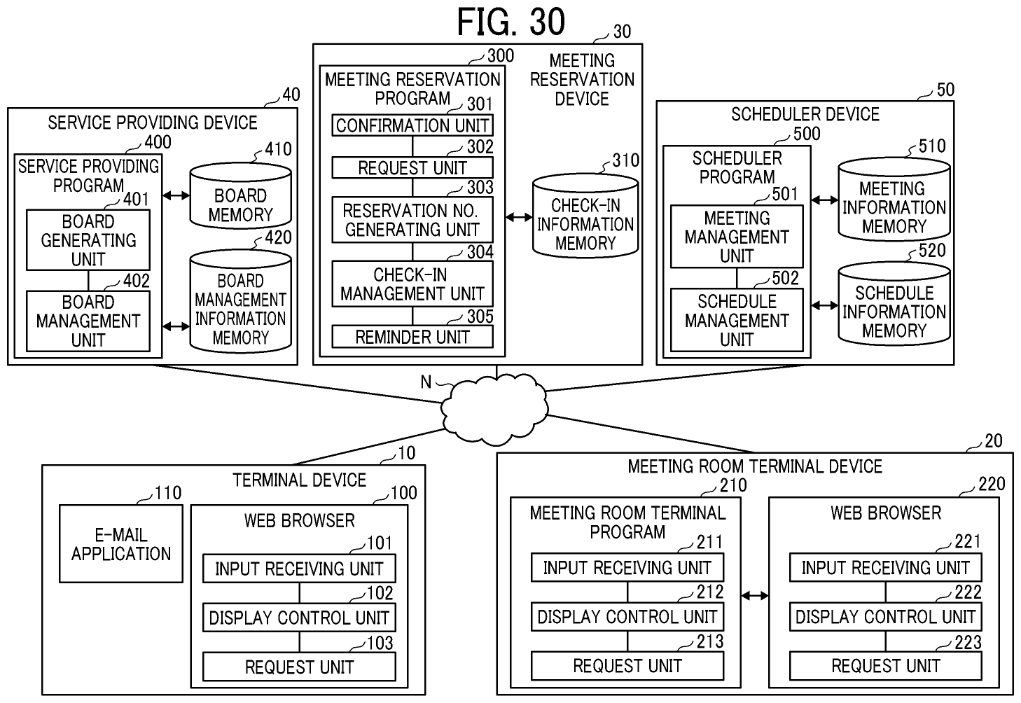

First, a functional configuration of the meeting service system 1 according to the present embodiment is described with reference to FIG. 30. FIG. 30 illustrates an example of a functional configuration of the meeting service system 1 according to the sixth embodiment. The functional configurations of the meeting room terminal device 20, the service providing device 40, and the scheduler device 50 are the same as those in the first embodiment, and thus are not described.

### Terminal Device

As illustrated in FIG. 30, the terminal device 10 according to the present embodiment includes an e-mail application 110. The terminal device 10 can send and receive e-mails by using the e-mail application 110.

### Meeting Reservation Device

As illustrated in FIG. 30, the meeting reservation device 30 according to the present embodiment includes a reminder unit 305. The reminder unit 305 is implemented by a process that the meeting reservation program 300 causes the CPU to execute.

The reminder unit 305 confirms whether it has become predetermined time before the date and time of the reserved meeting. Further, the reminder unit 305 sends a reminder notification to the terminal device 10 of the attendee of the meeting when it becomes predetermined time before the date and time of the reserved meeting.

Hereinafter, predetermined time before the date and time of the reserved meeting is held is referred to as “reminder notification time.” For example, if the date and time when the reserved meeting is held is “April 19, 2019, 16:00” and a reminder notification is sent three days before, the reminder notification time is “April 16, 2019, 16:00.” Similarly, for example, if the date and time when the reserved meeting is held is “April 19, 2019, 16:00” and a reminder notification is sent one hour before, the reminder notification time is “April 19, 2019, 15:00.”

### Details of Process

Next, details of the process of the meeting service system 1 according to the present embodiment are described.

### Meeting Reservation Process

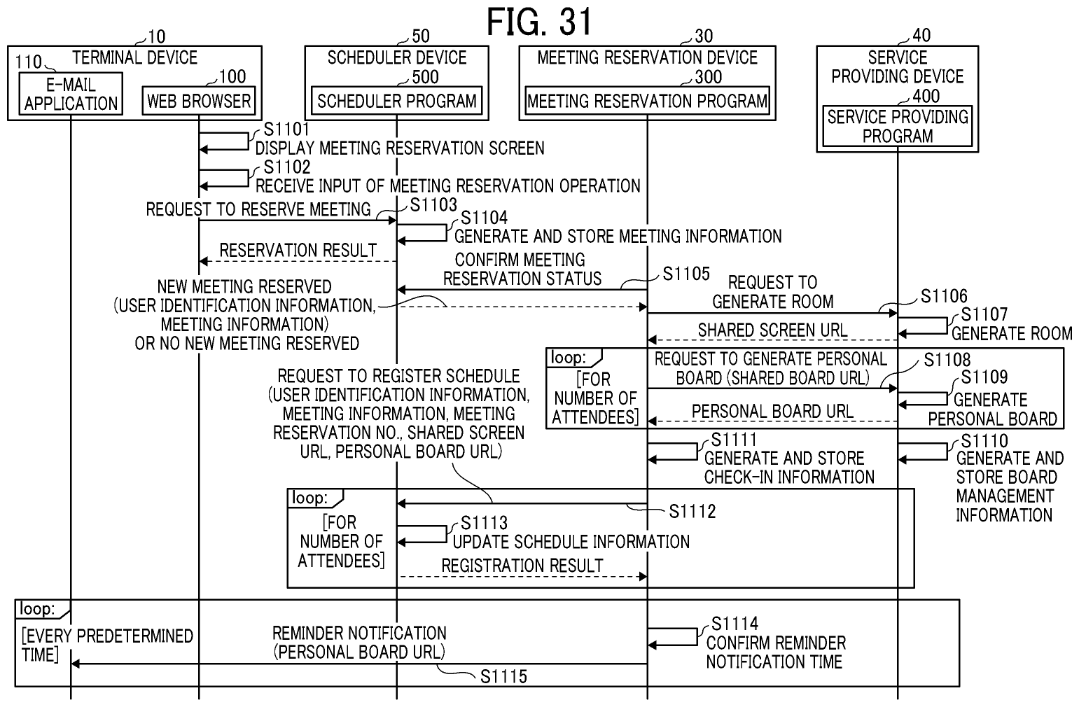

Hereinafter, a process for reserving an electronic meeting by using the meeting service system 1 according to the present embodiment is described with reference to FIG. 31. FIG. 31 is a sequence diagram illustrating an example of the meeting reservation process according to the sixth embodiment. Steps S1101 to S1105 in FIG. 31 are the same as steps S101 to S105 in FIG. 5, and thus are not described.

Subsequent to step S1105, the request unit 302 of the meeting reservation program 300 sends a request for generating a room (a room generation request) for a newly reserved meeting to the service providing device 40 (step S1106). The room generation request includes, for example, the meeting information or the date and time set in the meeting information.

Upon receiving the room generation request, the board generating unit 401 of the service providing program 400 generates a room related to the reserved meeting (step S1107). When room is generated, a room ID is generated as identification information for identifying a meeting (room), and a shared screen is generated. Then, the board generating unit 401 sends the shared screen URL back to the meeting reservation device 30. If the shared screen URL is expressed with a URL, only the room ID of which is changeable (that is, if the character strings of the shared screen URL are the same in all the rooms except for the characters corresponding to the room ID), the board generating unit 401 may sends the room ID back to the meeting reservation device 30.

Next, as in step S109 in FIG. 5, the request unit 302 of the meeting reservation program 300 sends, to the service providing device 40, a request to generate a personal board (a personal board generation request) used individually for each attendee of the newly reserved meeting (step S1108). At this time, the request unit 302 sends a personal board generation request to the service providing device 40 for each attendee (that is, user identification information) included in the meeting information sent back from the scheduler device 50. The personal board generation request includes information for identifying a shared screen corresponding to the personal board generated in step S1109 described later. Example of such information may include a shared screen URL, and a process ID when generating the shared screen. In this manner, the shared screen associated with the personal board generated in step S1109 described later can be identified.

The shared screen generation request in step S1106 described above and the personal board generation request in step S1108 may be performed in one generation request.

Upon receiving the personal board generation request, the board generating unit 401 of the service providing program 400 generates a personal board as in step S110 of FIG. 5 (step S1109).

Then, the board generating unit 401 sends the personal board URL back to the meeting reservation device 30. The personal board is stored in the board memory 410. In this manner, personal boards corresponding to the number of attendees of the reserved meeting are generated.

After generating the board management information, the board management unit 402 of the service providing program 400 stores the generated board management information in the board management information memory 420 (step S1110). In the present embodiment, the board management unit 402 associates the room ID generated in step S1107 described above, the shared screen URL of the shared screen generated in step S1107 described above, the personal board URL of the personal board generated in step S1109 described above, and the date and time of the reserved meeting, so as to generate board management information.

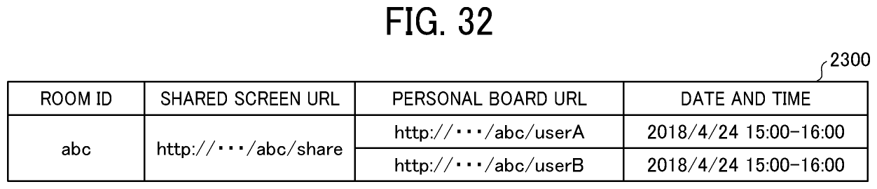

An example of the board management information generated in step S1110 described above is illustrated in FIG. 32. FIG. 32 illustrates an example of board management information 2300. The board management information 2300 illustrated in FIG. 32 includes, as data items, the room ID, the shared screen URL, the personal board URL, and the date and time.

In the data item “room ID,” the room ID generated in step S1107 described above is set. In the data item “shared screen URL,” the URL of the shared screen generated in step S1107 described above is set. In the data item “personal board URL,” the URL of each personal board generated in step S1109 described above is set. In the data item “date and time,” the date and time of the reserved meeting is set.

In the board management information 2300 illustrated in FIG. 32, “abc” is set as the room ID. Further, “http://.../abc/share” is set as the shared screen URL. Also, “http://.../abc/userA” and “http://.../abc/userB” are set as the personal board URL. Furthermore, “2018/4/24 15:00-16:00” is set as the date and time for each of these personal board URLs.

As described above, the board management information according to the present embodiment refers to information in which the room ID, the shared screen URL, the personal board URL, and the date and time are associated with each other. In the present embodiment, when a shared board is also generated, the shared board URL is also associated in the board management information described above. Although the URL is used as information for specifying the personal board and the shared screen in the embodiment, this configuration is not restrictive. Other information, such as URI and URN, for identifying web content may also be used.

Referring back to FIG. 31, the check-in management unit 304 of the meeting reservation program 300 generates check-in information and stores the generated check-in information in the check-in information memory 310 (step S1111). The check-in management unit 304 associates the shared screen URL sent back from the service providing device 40 in step S1107 described above with the meeting reservation number, so as to generate check-in information. The meeting reservation number may be generated and sent back in step S1107 described above, for example, or may be generated in step 1111.

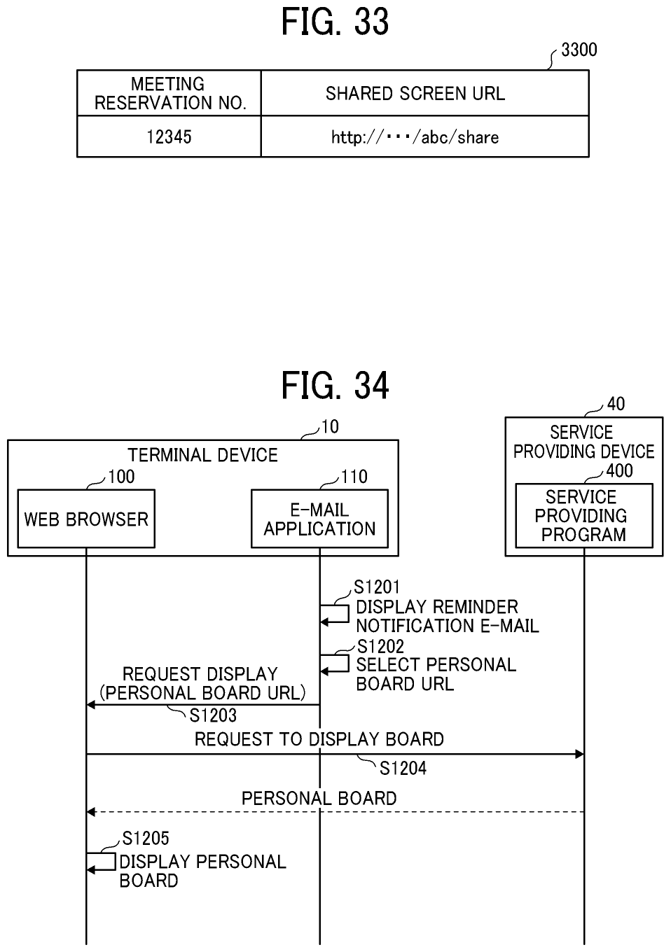

Here, an example of the check-in information generated in step S1111 described above is illustrated in FIG. 33. FIG. 33 illustrates an example of check-in infotmation 3300. The check-in information 3300 illustrated in FIG. 33 includes, as data items, the meeting reservation number, and the shared screen URL.

In the data item “meeting reservation number,” a meeting reservation number is set. In the data item “shared screen URL,” the shared screen URL sent back from the service providing device 40 in step S1107 described above is set.

In the check-in information 3300 illustrated in FIG. 33, “12345” is set as the meeting reservation number, and “http://.../abc/share” is set as the shared screen URL.

As described above, the check-in information according to the present embodiment refers to information in which a meeting reservation number and a shared screen URL are associated with each other.

Referring back to FIG. 31, the request unit 302 of the meeting reservation program 300 sends a schedule request to the scheduler device 50 for each attendee of the newly reserved meeting (step S1112). The schedule request includes the user identification information of the attendee of the meeting, the meeting information, the meeting reservation number, the shared screen URL, and the personal board URL of the attendee.

Upon receiving the schedule request, the schedule management unit 502 of the scheduler program 500 updates the schedule information stored in the schedule information memory 520 with various types of information included in the schedule information (step S1113). That is, the schedule management unit 502 specifies schedule information in which that user identification information is included among the schedule information stored in the schedule information memory 520. Then, the schedule management unit 502 updates the specified schedule information by using the meeting information, the meeting reservation number, the shared screen URL, and the personal board URL. After the updating, the schedule management unit 502 sends an update result (a result) back to the meeting reservation device 30.

The reminder unit 305 of the meeting reservation program 300 confirms, every predetermined time (for example, every few minutes), whether reminder notification time of the reserved meeting has come (step S1114). Then, when the reminder notification time of the reserved meeting comes, the reminder unit 305 of the meeting reservation program 300 sends a reminder notification e-mail to the terminal device 10 of the attendee of the meeting (step S1115). The reminder notification (e-mail) includes the personal board URL of the personal board of the attendee. The reminder notification (e-mail) may further include, for example, a shared screen URL and a shared board URL, in addition to the personal board URL.

Here, when the user identification information is an e-mail address, the e-mail address may be used as the destination of the reminder notification. When the user identification information is not an e-mail address, the user identification information and the e-mail address may be stored in the scheduler device 50 or the meeting reservation device 30 in association with each other, and the e-mail address associated with the user identification information may be used.

As described above, in the meeting service system 1 according to the present embodiment, when the reminder notification time of the reserved meeting comes, the reminder notifications are sent to the terminal devices 10 of the attendees of the meeting (accurately, the prospective attendees). In this manner, it is possible to prevent the attendees from forgetting to attend the meeting.

Note that multiple reminder notification times may be set for a single meeting. In this case, the reminder notification is sent at each of the multiple reminder notification times. For example, when two reminder notification times of “three hours before” and “one hour before” are set, the reminder notification is sent three hours before and one hour before the date and time of the meeting.

### Meeting Attendance Process

Hereinafter, a process in the case in which users are to attend the electronic meeting started by using the meeting service system 1 according to the present embodiment is described with reference to FIG. 34. FIG. 34 is a sequence diagram illustrating an example of a meeting attendance process according to the sixth embodiment. It is assumed that the user attending the meeting has received a reminder notification e-mail (hereinafter, also referred to as a “reminder notification e-mail”) in his/her own terminal device 10.

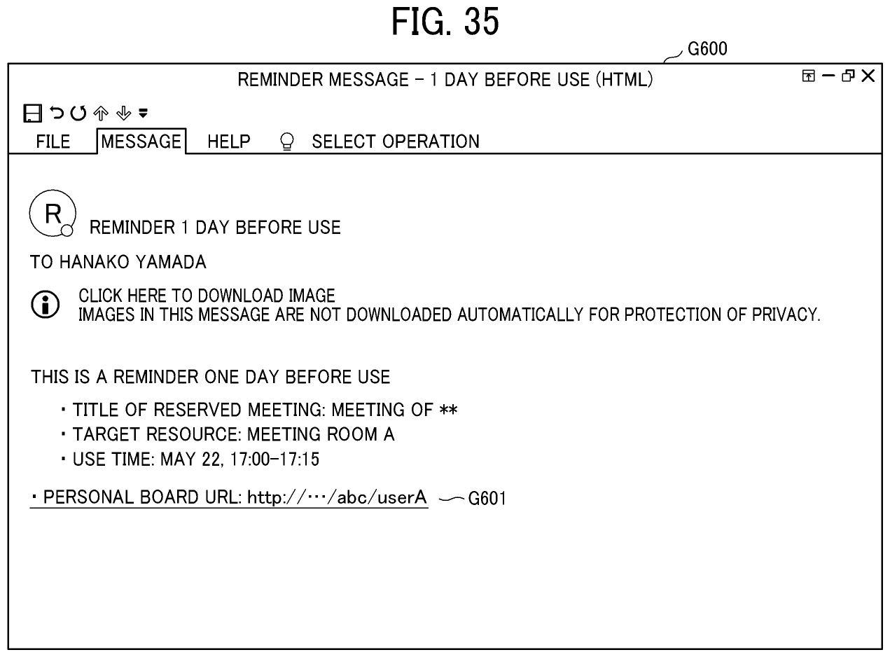

First, the e-mail application 110 displays a reminder notification e-mail in accordance with an operation of the user (step S1201). Here, an example of a screen G600 on which the reminder notification e-mail is displayed (a reminder notification e-mail screen) is illustrated in FIG. 35. FIG. 35 illustrates an example of a reminder notification e-mail screen G600. The reminder notification e-mail screen G600 illustrated in FIG. 35 is a screen on which the content of the reminder notification e-mail is displayed. The mail text includes a title of the reserved meeting and a place (a target resource), time the meeting room is to be used, and a link G601 of the personal board URL. By selecting the link G601 of the personal board URL, the user can display his/her personal board and attend the meeting. Hereinafter, description is given assuming that the link G601 of the personal board URL is selected by the user.

The e-mail application 110 receives the selection of the link G601 of the personal board URL (step S1202). Upon receiving the selection of the link G601, the e-mail application 110 sends a display request including the personal board URL corresponding to the link G601 to the web browser 100 (step S1203).

Next, the request unit 103 of the web browser 100 sends a board display request to the personal board URL (step S1204). In this manner, the service providing device 40 sends back the personal board indicated by the personal board URL (more accurately, the web content for displaying the personal board).

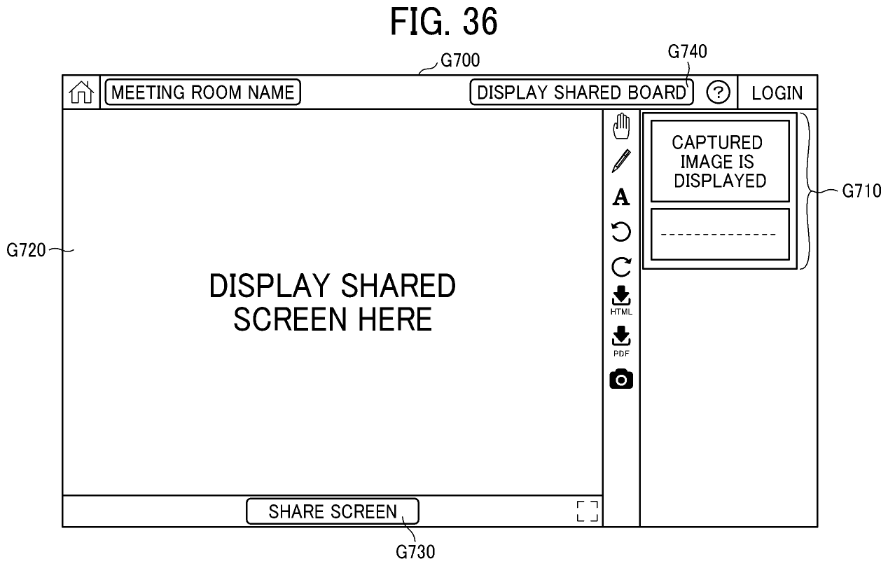

When the personal board is sent back, the display control unit 102 of the web browser 100 displays, for example, a personal board screen G700 illustrated in FIG. 36 (step S1205). The personal board screen G700 illustrated in FIG. 36 includes a personal board display field G710 and a shared screen display field G720. In the personal board display field G710, a personal board is displayed. In the shared screen display field G720, a shared screen is displayed. In this manner, in the personal board screen G700 illustrated in FIG. 36, both the personal board and the shared screen can be displayed on a single screen. The shared screen displayed in the shared screen display field G720 may be a shared screen generated for each room, or a screen displayed on another terminal device 10 attending the same meeting.

By pressing a screen sharing button G730, the user can cause a screen displayed on his/her terminal device 10 (the shared screen) to be displayed on the shared screen display fields G720 of other terminal devices 10 attending the same meeting. At this time, the shared screen may be sent directly to other terminal devices 10, or may be sent via an arbitrary server, such as the service providing device 40.

Further, by pressing a shared board display button G740, the user may also cause the shared board to be displayed.

As described above, in the meeting service system 1 according to the present embodiment, the user of each terminal device 10 can access the personal board by using the personal board URL included in the reminder notification and attend the electronic meeting. In the present embodiment, the personal board screen G700 illustrated in FIG. 36 is displayed in step S1205 described above, however, the personal board screen G300 illustrated in FIG. 14 may be displayed as in the first embodiment. The information processing system described in one or more embodiments above may be managed in association with shared content and personal content in an electronic meeting.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information processing system comprising:
circuitry configured to:
acquire information on reservation of a meeting;
in response to the acquisition of the information on the reservation of the meeting, generate personal content to be used by each of attendees of the reserved meeting; and
based on the information on the reservation, send a notification indicating connection information for accessing the personal content and shared content to be shared and used by the attendees of the reserved meeting.

2. The information processing system according to claim 1, wherein
in response to the acquisition of the information on the reservation of the meeting, the circuitry further generates the shared content.

3. The information processing system according to claim 1, wherein
the information on the reservation includes information on the attendees of the reserved meeting, and
the circuitry generates, for each of the attendees, personal content to be used by the attendee.

4. The information processing system according to claim 3, wherein
the circuitry generates a shared board corresponding to the reservation, and generates personal boards corresponding to the number of attendees.

5. The information processing system according to claim 1, wherein
the circuitry generates a meeting reservation number for starting the reserved meeting, and sends the meeting reservation number in the notification.

6. The information processing system according to claim 1, wherein
after the meeting ends, the circuitry deletes personal content that has not been used in the meeting.

7. The information processing system according to claim 1, wherein
the connection information for accessing the shared content is a URL common to a plurality of terminal devices of attendees of the same meeting, and
the connection information for accessing the personal content is a URL different for each personal content.

8. The information processing system according to claim 1, wherein
the circuitry sends the notification through one of: of a scheduling service, e-mail transmission, and use of a message service.

9. An information processing device comprising:
circuitry configured to:
acquire information on reservation of a meeting;
in response to the acquisition of the information on the reservation of the meeting, requests generation of personal content to be used by each of attendees of the reserved meeting; and
based on the information on the reservation, sends a notification indicating connection information for accessing the personal content and shared content to be shared and used by the attendees of the reserved meeting.

10. The information processing device according to claim 9, wherein
in response to the acquisition of the information on the reservation of the meeting, the circuitry further requests generation of the shared content.

11. The information processing device according to claim 9, wherein
the information on the reservation includes information on the attendees of the reserved meeting, and
the circuitry requests, for each of the attendees, generation of personal content to be used by the attendee.

12. The information processing device according to claim 11, wherein
the circuitry requests generation of a shared board corresponding to the reservation, and requests generation of personal boards corresponding to the number of attendees.

13. The information processing device according to claim 9, wherein
the circuitry generates a meeting reservation number for starting the reserved meeting, and sends the meeting reservation number in the notification.

14. The information processing device according to claim 9, wherein
after the meeting ends, the circuitry requests to delete personal content that has not been used in the meeting.

15. An information processing method, comprising:
acquiring information on reservation of a meeting;
in response to the acquisition of the information on the reservation of the meeting, requesting generation of personal content to be used by each of attendees of the reserved meeting; and
based on the information on the reservation, sending a notification indicating connection information for accessing the personal content and shared content to be shared and used by the attendees of the reserved meeting.
